(19) United States
(12) Patent Application Publication
(10) Pub. No.: US 2026/0162218 A1
(43) Pub. Date: Jun. 11, 2026

(54) METHOD FOR ADAPTING TRAINED GENERATIVE MACHINE LEARNING MODELS

(71) Applicant: SAMSUNG ELECTRONICS CO., LTD., Suwon-si (KR)

(72) Inventors: Adrian BULAT, Chertsey (GB); Isma Hadji, Chertsey (GB); Brais Martinez Alonso, Chertsey (GB); Hai Xuan Pham, Chertsey (GB); Georgios Tzimiropoulos, Chertsey (GB); Haosen Yang, Chertsey (GB)

(73) Assignee: SAMSUNG ELECTRONICS CO., LTD., Suwon-si (KR)

(21) Appl. No.: 19/529,834

(22) Filed: Feb. 4, 2026

Related U.S. Application Data
(63) Continuation of application No. PCT/KR2025/018427, filed on Nov. 10, 2025.

(30) Foreign Application Priority Data
Nov. 13, 2024 (GR) 20240100804
Oct. 20, 2025 (EP) 25209901.5

(51) Int. Cl. G06T 3/4046; G06N 3/04; G06T 3/4053; G06T 5/50; G06T 5/60; G06T 5/70; G06T 5/73

(52) U.S. Cl. CPC G06T 3/4046; G06N 3/04; G06T 3/4053; G06T 5/50; G06T 5/60; G06T 5/70; G06T 5/73; G06T 2207/20084

(57) ABSTRACT

A method for generating, on an electronic device, high-resolution images using a generative machine learning, ML, model is provided. The method may comprise obtaining a text prompt to generate an image, and a first noisy image. The method may comprise generating a first image according to the text prompt and at an initial resolution, by denoising the first noisy image using the generative ML model over a plurality of first denoising timesteps. The method may comprise upsampling, using an upsampling module, the generated first image to produce a second image having a target resolution. The method may comprise adding noise to the second image using the generative ML model over a plurality of noising timesteps, to generate a second noisy image at the target resolution. The method may comprise generating a third image at the target resolution.

### CROSS-REFERENCE TO RELATED APPLICATION(S)

This application is a continuation application, claiming priority under § 365(c), of an International application No. PCT/KR2025/018427, filed on Nov. 10, 2025, which is based on and claims the benefit of a Greek patent application number 20240100804, filed on Nov. 13, 2024, in the Hellenic Industrial Property Organization, and a European patent application number 25209901.5, filed on Oct. 20, 2025, in the European Patent Office, the disclosure of which is incorporated herein by reference in its entirety.

### TECHNICAL FIELD

The present application generally relates to a method for adapting trained generative machine learning, ML, models. In particular, the present application provides a method to adapt trained generative diffusion-based models, without additional training, to generate high resolution images which have a higher resolution than a native resolution of the models.

### BACKGROUND

Diffusion models demonstrate impressive generative power across a range of applications. While powerful, one known shortcoming of diffusion models is their inability to seamlessly scale to higher resolutions beyond the one used during training. It is known that directly generating images at resolutions beyond the training resolution results in severe object repetition and unrealistic local patterns. This is illustrated in FIG. 1A. While retraining diffusion models on higher-resolution images is a straightforward solution, the computational demands quickly become prohibitive. This restricts applications requiring flexible or high-resolution image generation, e.g., 4K. Therefore, adapting pre-trained diffusion models to generate high-resolution images without additional training is a topic of high interest that we tackle in this disclosure.

Related efforts addressing this important problem can be largely categorized into two tracks. The first set of approaches propose mechanisms that improve the global structure consistency by steering the high-resolution generation using the image generated at native (e.g., training) resolution. However, the effectiveness of such mechanisms is mixed, with trailing issues like poor detail quality, inconsistent local textures, and even persisting pattern repetitions as shown in FIG. 1B. Furthermore, these works typically operate on a patch-based basis, generating one patch at a time. Concretely, this means that these methods resort to redundant and overlapping forward passes, leading to large latency overheads. The second group of approaches eschews patch-based generation in favor of a one-pass approach by directly altering the model architecture. This leads to faster generation, but unfortunately, it comes at the cost of image quality, as shown in FIG. 1C.

The present applicant has therefore identified the need to adapt diffusion models so that they can generate images of a resolution higher than the resolution used during training of the models.

### SUMMARY

According to an aspect of the disclosure, a method for generating, on an electronic device, high-resolution images using a generative machine learning, ML, model is provided. The method may comprise obtaining a text prompt to generate an image, and a first noisy image. The method may comprise generating a first image according to the text prompt and at an initial resolution, by denoising the first noisy image using the generative ML model over a plurality of first denoising timesteps, wherein the generative ML model may have been trained using images having the initial resolution. The method may comprise upsampling, using an upsampling module, the generated first image to produce a second image having a target resolution, wherein the target resolution may be higher than the initial resolution. The method may comprise adding noise to the second image using the generative ML model over a plurality of noising timesteps, to generate a second noisy image at the target resolution, by: adding noise to a latent representation of the second image generated at a previous noising timestep, and storing the noised latent representation. The method may comprise generating a third image at the target resolution, by: denoising the second noisy image using the generative ML model over a plurality of second denoising timesteps, wherein each second denoising timestep may correspond to a noising timestep, and during the each second denoising timestep, ensuring global structural features in the second image are maintained, wherein the global structural features may be obtained from the stored noised latent representation for the corresponding noising timestep.

According to an aspect of the disclosure, an electronic device for generating high-resolution images using a generative machine learning, ML, model is provided. The electronic device may comprise memory storing instructions and at least one processor operatively coupled to the memory and comprising processing circuitry. The at least one processor may individually or collectively execute the instructions to cause the electronic device to obtain a text prompt to generate an image, and a first noisy image. The at least one processor may individually or collectively execute the instructions to cause the electronic device to generate a first image according to the text prompt and at an initial resolution, by denoising the first noisy image using the trained generative ML model over a plurality of first denoising timesteps, wherein the generative ML model may have been trained using images having the initial resolution. The at least one processor may individually or collectively execute the instructions to cause the electronic device to upsample, using an upsampling module, the generated first image to produce a second image having a target resolution, wherein the target resolution may be higher than the initial resolution. The at least one processor may individually or collectively execute the instructions to cause the electronic device to add noise to the second image using the generative ML model over a plurality of noising timesteps, to generate a second noisy image at the target resolution, by: adding noise to a latent representation of the second image generated at a previous noising timestep, and storing the noised latent representation in storage on the electronic device. The at least one processor may individually or collectively execute the instructions to cause the electronic device to generate a third image at the target resolution, by: denoising the second noisy image using the generative ML model over a plurality of second denoising timesteps, wherein each second denoising timestep may correspond to a noising timestep, and during the each second denoising timestep, ensuring global structural features in the second image are maintained, wherein the global structural features may be obtained from the stored noised latent representation for the corresponding noising timestep.

According to an aspect of the disclosure, a computer-readable storage medium storing instructions is provided. The instructions, when executed by at least one processor, may cause the at least one processor to perform the method corresponding.

### BRIEF DESCRIPTION OF THE DRAWINGS

Implementations of the present techniques will now be described, by way of example only, with reference to the accompanying drawings, in which:

FIGS. 1A to 1C illustrate the limitations of related techniques to generate high resolution images according to an embodiment of the disclosure;

FIG. 1D illustrates example results of the present techniques when generating high resolution images according to an embodiment of the disclosure;

FIG. 2A illustrates a block diagram illustrating how image generation models operate (left), and how the present techniques adapt the capabilities of models at inference time (right) according to an embodiment of the disclosure;

FIG. 2B illustrates a simplified flowchart of example operations to implement the present techniques according to an embodiment of the disclosure;

FIGS. 3A to 3C illustrate schematic diagrams showing overviews of the FAM diffusion method of the present techniques according to an embodiment of the disclosure;

FIGS. 4A to 4E illustrate ablation on the components of FAM diffusion according to an embodiment of the disclosure;

FIG. 5A illustrates a standard text-to-image generation pipeline according to an embodiment of the disclosure;

FIG. 5B illustrates a modified text-to-image generation pipeline for the FAM diffusion process of the present techniques according to an embodiment of the disclosure;

FIG. 6 illustrates a flowchart of example operations for generating high-resolution images using a pre-existing trained diffusion-based generative machine learning, ML, model according to an embodiment of the disclosure;

FIG. 7 illustrates a schematic diagram illustrating the Frequency Modulation (FM) process according to an embodiment of the disclosure;

FIG. 8 illustrates a block diagram showing example operations for generating a frequency-modulated version of a latent representation during each second denoising timestep according to an embodiment of the disclosure;

FIG. 9 illustrates a schematic diagram illustrating the Attention Modulation (AM) process according to an embodiment of the disclosure;

FIG. 10A illustrates a standard attention pipeline according to an embodiment of the disclosure;

FIG. 10B illustrates a modified attention pipeline for the FAM diffusion process of the present techniques according to an embodiment of the disclosure;

FIG. 11A illustrates a table showing results of system-level comparisons with SDXL according to an embodiment of the disclosure;

FIG. 11B illustrates a table showing results of system-level comparisons with SDXL at different aspect ratios according to an embodiment of the disclosure;

FIG. 12 illustrates a comparison between images generated using constant low-frequency information (left) and time-aware low-frequency information (right) according to an embodiment of the disclosure;

FIG. 13 illustrates visualization for the self-attention maps of tokens from a specific area of an image according to an embodiment of the disclosure; and

FIG. 14 illustrates a block diagram of an electronic device for adapting a trained generative ML model to generate high-resolution images according to an embodiment of the disclosure.

### DETAILED DESCRIPTION

In a first aspect of the present techniques, there may be provided a computer-implemented method for generating, on an electronic device, high-resolution images using a trained diffusion-based generative machine learning, ML, model, the method comprising: obtaining a text prompt to generate an image, and a first noisy image; generating a first image according to the text prompt and at an initial (native) resolution (e.g., a denoised image at the native/initial resolution), by denoising the first noisy image using the trained generative ML model over a plurality of first denoising timesteps, wherein the trained generative ML model may have been trained using images having the initial resolution; upsampling, using an upsampling module, the generated first image to produce a second image having a target resolution, wherein the target resolution may be higher than the initial resolution; adding noise to the second image using the trained generative ML model over a plurality of noising timesteps, to generate a second noisy image at the second target resolution, by: adding noise to a latent representation of the second image generated at a previous noising timestep; and storing the noised latent representation; and generating a third image at the target resolution (e.g., a denoised image at the higher, target resolution), by: denoising the second noisy image using the trained generative ML model over a plurality of second denoising timesteps, wherein each second denoising timestep may correspond to a noising timestep, and during each second denoising timestep, ensuring global structural features in the second image are maintained, wherein the global structural features may be obtained from the stored noised latent representation for the corresponding noising timestep.

Advantageously, the present techniques may provide a simple, training-free way to enable a trained diffusion-based generative ML model to generate images (single images, or frames for videos) that have an image resolution that is higher than the resolution the model has been trained to produce. This may be useful because it enables related trained models to be adapted to produce higher resolution images without having to undergo a time-consuming and computationally-expensive retraining process. That is, once the trained model has been deployed on electronic devices (such as smartphones and laptops), it is undesirable to have to retrain the model to produce higher resolution images.

Furthermore, the present techniques advantageously overcome the problems with the related techniques, namely that of repetitive patterns and structural distortions. When related models attempt to generate images at a higher resolution than the resolution the model was trained to produce, the resulting images contain artifacts, repeated features and distortions. These arise because the model does not know how to ‘fill’ the additional pixels of the higher resolution, and can simply add in duplicate features. For example, if a user wished to generate an image showing a boy on a grass field kicking a football, the model may generate a higher resolution image that shows the boy having excess limbs, or having multiple footballs. This is clearly undesirable and leads to poor quality higher resolution images. The present techniques overcome these issues in two ways. Firstly, the present techniques utilise a mechanism to ensure that global structural features or information are maintained between an image generated at an initial resolution (e.g., a resolution the model is trained to generate) and the final image at the higher target resolution (e.g., a resolution higher than what the model is trained to generate). This ensures that, for example, the boy has only two arms and two legs, and that there is a single football. Secondly, the present techniques utilise a mechanism to ensure that local structural features appear in the right places in the final image. This ensures that, for example, the texture or colours of the football appear on the football and not on the boy's clothes or on the field. These two methods will be described in more detail below and with reference to the Figures. Advantageously, the two methods do not require any changes to the trained model itself—instead, these methods are implemented via modules that control the inputs into the model during the image generation process.

Diffusion models are a class of generative machine learning, ML, models which learn a diffusion process that generates a probability distribution of a given dataset. Diffusion models are used to generate new data samples based on the data they have been trained on. For example, a diffusion model that has been trained on an image dataset depicting human faces can generate new images of human faces with various features and expressions, even if those new faces were not present in the original training dataset. Diffusion models have shown impressive performance in various image generation tasks, including image super-resolution and restoring missing areas of an image.

Diffusion models have three main components: a forward process, a reverse process, and a sampling process. During the forward process (also known as forward diffusion, or simply diffusion process), the model applies a sequence of transformations to diffuse samples in a training dataset (having a ‘complex’ distribution) until a desired simple data points distribution is reached. Each step in the process introduces more simplicity until all that is left is simple noise with original patterns obscured by this noise. An example of this noisy, simple, distribution may be a white noise distribution, or the noise may be distributed in any other way. During the reverse process (also known as reverse diffusion or denoising), the model generates a sample from the simple data points distribution, and then maps it back to a complex distribution by inverting the transformations. The diffusion model uses a conditioning, or prompt, to generate an image using the reverse process. That is, the conditioning is used to guide the denoising process and determine the content of the final image. In this way, diffusion models can generate new data samples by starting from a point in the simple distribution and diffusing it step-by-step to the desired complex data distribution. The whole training process can be thought of as destroying the training dataset samples through the successive addition of Gaussian noise, and learning to recover the data by reversing this noising process (e.g., denoising). Once trained, new samples can be generated by passing randomly sampled noise through the learned denoising process. This is the sampling process (e.g., new sample generation process).

The present techniques comprise adapting a trained diffusion model. The diffusion model may have been trained, using the process described above, to generate images using prompts (e.g., text prompts). The diffusion model may have been trained on a server. The diffusion model may comprise a plurality of linear layers for performing simple linear transformations on inputs. The linear layers may be feed-forward layers.

The term “initial resolution” is used herein to mean a (maximum) native resolution of the trained diffusion model. The diffusion model may have been trained using images having this initial resolution and as such, has learned how to generate images at this initial resolution. For example, the initial resolution may be 512×512 pixels, 768×768 pixels, or 1024×1024 pixels. It will be understood these are simply illustrative example values for the initial resolution, and are not limiting. The initial resolution is referred to herein as 1×.

The terms “high resolution” and “target resolution” are used herein to mean a resolution that is higher than the initial/native resolution of the trained diffusion model. The target resolution may be higher in one dimension or both dimensions. For example, the target resolution may be 2×2, 3×3, or 4×4 times larger than the initial resolution, meaning that the generated image has twice, three times or four times the number of pixels in both dimensions. In an example, the target resolution may be 2×4 larger than the initial resolution, meaning that the generated image has twice the number of pixels in one dimension, and four times the number of pixels in the other dimension. It will be understood these are simply illustrative example values for the target resolution, and are not limiting.

The term “upsampling” is used herein to mean increasing the resolution of an image. The term “upsampling module” is used herein to mean any module, function or routine for performing the upsampling.

The term “latent representation” is used herein to mean a representation of important features of an image, which is also sometimes referred to as an embedding. A latent representation or embedding is a representation of values or objects, like text, images or audio, that can be understood and processed by machine learning models. A latent representation or embedding usually takes the form of a vector, and thus the terms “latent representation”, “embedding” and “embedding vector” are used interchangeably herein. An embedding is therefore a mathematical representation of a data item (e.g., text, image, video, audio, etc.), and may represent some or all of the content of the data item. For example, an embedding may represent the semantic meaning of a data item. Embeddings make it possible for machine learning models to understand the relationships between different data items. Embeddings are normally analysed within embedding space or latent space, e.g., a mathematical space in which similar items are positioned closer to one another than less similar items. For example, if embedding A for data item A is close to embedding B for data item B in embedding space, then data item A and data item B are similar in some way.

The terms “global structural features” and “global structural information” are used interchangeably herein to mean high-level features of an image. For example, in the above-mentioned example, the global structural features may include the features of a human boy (e.g., head, torso, two arms, two legs, etc), a ball, and a field, as well as the structural or positional relationships between them (e.g., the arms are connected to the torso and not to the ball). The global structural features could also include colour information, patterns, textures, and so on. For example, in the above-mentioned example, the global structural features may include the colour of the field. It will be understood that the exact nature of the global structural features will vary for each image. Ultimately, the global structural features are low frequency features which do not change across an image. One way to think about this is to consider which details would disappear if an image were, for instance, downsized or blurred heavily. (Imagine a person with bad eyesight removing their glasses and looking at the image: what would they still be able to see when the image appears blurry to them?) Effectively, the features which remain are the low frequency features, which are referred to herein as “global structural information”, and the features which are lost are the high frequency features, which are referred to herein as “local textural information”.

The terms “local structural features”, “local structural information” and “local textural features” are used interchangeably herein to mean low-level features of an image, such as colour, texture, and so on. For example, in the above-mentioned example, the local structural features may include the colour of the ball, the texture of the grass, etc. It will be understood that the exact nature of the local structural features will vary for each image. As explained above, the local structural features are high frequency features which change across an image, and which may disappear if an image were downsized or heavily blurred.

Preferably, the method further comprises: displaying the generated third image on a display of the electronic device. The target resolution may be the same as a resolution of the display of the electronic device.

Generating the third image may comprise, at each second denoising timestep of the plurality of second denoising timesteps, the following further operations: generating, using a frequency modulation module, a frequency-modulated version of the second noisy image, wherein the frequency modulation module may ensure global structural features are maintained; and inputting the frequency-modulated version of the second noisy image into the trained generative ML model for denoising. The frequency modulation, FM, module may be any module, function or routine which is able to produce a frequency-modulated version of the second noisy image. In this way, the FM module may control what is input into the trained generative ML model during the second denoising operations, and therefore, may help to ensure that global structural features are maintained during the second denoising.

Specifically, at each second denoising timestep, generating a frequency-modulated version of the second noisy image may comprise: inputting the stored noised latent representation of the corresponding noising timestep and the denoised latent representation of the second denoising timestep into the frequency modulation, FM, module. To enable the FM module to maintain global structural features, it may need to know what these features are. For example, prior to each second denoising timestep, the FM module may be given the stored noised latent representation from the corresponding noising timestep because this may include the global structural features from the upsampled second image. This may be because the second image may be generated by simply upsampling the first image, and so maintain the structural information (local and global). The FM module may also be given the denoised latent representation, so that the FM module can effectively affect how the trained ML model denoises the denoised latent representation to ensure the global structural information is maintained during the denoising. It may be important that the two inputs into the FM module correspond to the same timesteps to ensure that the denoising occurs smoothly. That is, the T-th noised latent representation may be input together with the T-th denoised latent representation.

At each second denoising timestep, generating a frequency-modulated version of the latent representation may comprise: applying a low-pass filter to the stored noised latent representation of the corresponding noising timestep, to retain low-frequency components of the stored noisy latent representation, wherein the low-frequency components may correspond to global structural features in the second image. The low-pass filter may be part of the FM module and may be applied to the stored noisy latent representation (obtained from the second image). The low-pass filter may be used to identify the low-frequency components (effectively of the second image), so that these components can be maintained during the current second denoising timestep by the trained ML model.

At each second denoising timestep, generating a frequency-modulated version of the latent representation may comprise: applying a high-pass filter to the denoised latent representation of the second denoising timestep, to retain high-frequency components of the denoised latent representation, wherein the high-frequency components may correspond to local structural features in the second image. The high-pass filter may be part of the FM module and may be applied to the denoised latent representation that is to be processed by the trained ML model during the current second denoising timestep. The high-pass filter may be used to identify the high-frequency components (effectively from the previous denoising operation), so that these components can be maintained during the current second denoising timestep by the trained ML model. In other words, it may be desirable to maintain the high-frequency components generated during the previous denoising operation in the current denoising operation, because these have been generated by the trained ML model during the denoising and are likely important local structural features. Thus, these high-frequency components from the denoising may be maintained as well as the low-frequency components from the noising process.

The high-pass filter may be used to retain local structural features such as, for example: colour information; texture information; pattern information. It will be understood that these are non-limiting examples of local structural features. As explained above, broadly speaking, local structural features may be high frequency features which change across an image and are likely to disappear if the image were downsized or made blurry. For example, the colour green of a field may remain in an image if it were downsized, but the texture of the field (e.g., the blades of grass) may be lost.

At each second denoising timestep, generating a frequency-modulated version of the latent representation may comprise: combining the retained low-frequency components of the stored noised latent representation and the retained high-frequency components of the denoised latent representation, to generate the frequency-modulated version of the latent representation of the second noisy image. Thus, to ensure that the high-frequency components generated during the previous denoising operation and the low-frequency components from the noising process are maintained, the retained components may be combined, such as by summing.

For example, prior to generating a frequency-modulated version of the second noisy image, the method may comprise: converting, using a Fast Fourier Transform, FFT, the stored noised latent representation of the corresponding noising timestep and the denoised latent representation of the second denoising timestep into a Fourier domain. An FFT may be an algorithm for converting a signal from its original domain (e.g., image/pixel space) to a representation in the frequency domain. This may help to perform the frequency modulation operations, as the high and low frequency components (e.g., local and global structural information) are more easily discernible in the frequency domain than in the original domain.

For example, prior to inputting the frequency-modulated version of the second noisy image into the trained generative ML model for denoising, the method may comprise: applying an inverse Fast Fourier Transform to the generated frequency-modulated version of the latent representation of the second noisy image. Thus, the reverse of the FFT process may be performed to convert the summed components back into a form that the trained ML model is able to understand.

As mentioned above, the FM module may ensure that global structural features are maintained between the noising and second denoising processes (e.g., number of footballs). The FM module may also ensure that local structural features are maintained between timesteps of the second denoising process (e.g., colour, shape and texture of the football). However, the trained ML model may not understand how those local structural features fit in with the global structural features (e.g., whether the colour of the football only applies to the football or also to the boy). Thus, to ensure that the local structural features and global structural features are correctly merged in the generated third image, it may be necessary to control where the trained ML model adds the local structural features in the third image. To do this, the present techniques utilise an attention modulation, AM, module. The attention modulation, AM, module may be any module, function or routine which is able to cause the trained ML model to pay attention to where the local structural features should appear in the third image.

The operation of generating the first image by denoising the first noisy image may comprise: generating, at each first denoising timestep, an attention map at the initial resolution, wherein each attention map may guide the trained generative ML model to focus on particular parts of the first noisy image; and storing the generated attention maps. “Attention” may be a well-known mechanism in machine learning that determines the importance of each component in a sequence relative to other components in the sequence. This may be used in image processing to determine which features of an image or regions of an image are most relevant to the image processing task. The term “attention map” is used herein to mean a heatmap which encodes relationships between features. An input tensor X may be projected into two tensors (a keys tensor K, and a values tensor V), which semantic abstractions of the input tensor at specific spatial locations, and usually have the same dimensionality as X. If there are no input tokens, then an attention matrix A may be n×n. The value at positions i,j may be computed as the cosine similarity between K at spatial position i and V at spatial position j. Intuitively speaking, the attention matrix (e.g., map) tells you how semantically similar the features at position i are to the features at position j (thus it captures pairwise relationships more than task relationship).

For example, prior to storing, the method may further comprise: upsampling, using the upsampling module, the generated attention maps at the initial resolution to produce upsampled attention maps having the target resolution. This may ensure that the upsampled attention maps are useable by the attention modulation module, because they are of the right size/dimension.

At each second denoising timestep of the plurality of denoising timesteps, the process of generating the third image may comprise: generating an attention map at the target resolution; and incorporating, using an attention modulation module, information from the stored upsampled attention map from a corresponding first denoising timestep into the generated attention map at the target resolution, to thereby transfer local structural features from the first image to the third image. That is, a new attention map may be generated by the attention modulation module, by performing attention on the second denoising latent representation prior to further processing by the trained ML model. Attention may be a standard process in diffusion models, and therefore, the attention process may effectively be modified so that information from the native resolution attention map is included when the attention at the high resolution is being performed by the ML model. This may mean the attention modulation module is simply a modified part of the usual attention part of the ML model. Then, information from an upsampled attention map generated for a corresponding first denoising timestep may be incorporated into the new generated attention map, so that the new attention map may include the attention information from the original denoising process that was used to generate the first image. There may be multiple points within the denoising performed by the ML model where attention is performed. This may mean that the attention performed by layer L for the native resolution feeds into the attention performed by layer L for the high resolution, and so on.

As explained in more detail with reference to the Figures, the trained generative ML model may comprise a plurality of layers. The method may further comprise: incorporating information from the stored upsampled attention map into the generated attention map during processing by a subset of the plurality of layers of the trained generative ML model. That is, the attention mechanism employed by layers of the trained ML model may be modified by the attention modulation module.

In some cases, the trained generative ML model may comprise a U-Net. A U-Net may be a convolutional neural network architecture that was developed for image segmentation but is also used in diffusion models for iterative image denoising. In such cases, incorporating information from the stored upsampled attention map during processing by a subset of the plurality of layers of the trained generative ML model may comprise incorporating information from the stored upsampled attention map during processing by a subset of the plurality of layers in up-blocks of the U-Net.

The present techniques are described with reference to generating high resolution single/static images, but it will be understood that the present techniques can also be applied to the generation of high resolution videos. In the case of videos, the present techniques may operate on a frame-by-frame basis.

Thus, obtaining a text prompt to generate an image may comprise obtaining a text prompt to generate a single image. In this case, generating a third image at the target resolution may comprise generating a single image.

Alternatively, obtaining a text prompt to generate an image may comprise obtaining a text prompt to generate a video comprises a plurality of frames. In this case, generating a third image at the target resolution may comprise generating a plurality of frames.

In a second aspect of the present techniques, there may be provided an electronic device for generating high-resolution images using a trained diffusion-based generative machine learning, ML, model, the electronic device comprising: at least one processor coupled to memory, for: obtaining a text prompt to generate an image, and a first noisy image; generating a first image according to the text prompt and at an initial resolution, by denoising the first noisy image using the trained generative ML model over a plurality of first denoising timesteps, wherein the trained generative ML model may have been trained using images having the initial resolution; upsampling, using an upsampling module, the generated first image to produce a second image having a target resolution, wherein the target resolution may be higher than the initial resolution; adding noise to the second image using the trained generative ML model over a plurality of noising timesteps, to generate a second noisy image at the second target resolution, by: adding noise to a latent representation of the second image generated at a previous noising timestep; and storing the noised latent representation in storage on the electronic device; and generating a third image at the target resolution, by: denoising the second noisy image using the trained generative ML model over a plurality of second denoising timesteps, wherein each second denoising timestep may correspond to a noising timestep, and during each second denoising timestep, ensuring global structural features in the second image are maintained, wherein the global structural features may be obtained from the stored noised latent representation for the corresponding noising timestep.

The features described above with respect to the first aspect apply equally to the second aspect and therefore, for the sake of conciseness are not repeated.

As explained above, generating the third image may comprise, at each second denoising timestep of the plurality of second denoising timesteps: generating, using a frequency modulation module, a frequency-modulated version of the second noisy image, wherein the frequency modulation module may ensure global structural features are maintained; and inputting the frequency-modulated version of the second noisy image into the trained generative ML model for denoising.

As explained above, generating the first image by denoising the first noisy image may comprise: generating, at each first denoising timestep, an attention map at the initial resolution, wherein each attention map may guide the trained generative ML model to focus on particular parts of the first noisy image; and storing the generated attention maps in the storage.

Generating the third image may comprise, at each second denoising timestep of the plurality of denoising timesteps: generating an attention map at the target resolution; and incorporating, using an attention modulation module, information from the stored attention map from a corresponding first denoising timestep into the generated attention map at the target resolution, to thereby transfer local structural features from the first image to the third image.

The memory may store instructions that, when executed by the at least one processor individually or collectively, cause the at least one processor to perform the methods described herein.

The electronic device may be a smart device. The electronic device may be a smartphone. A smartphone is an example of a smart device. The electronic device may be a smart appliance. A smart appliance is another example of a smart device. An example of a smart appliance is a smart television (TV), a smart fridge, a smart oven, a smart vacuum cleaner, a smart robotic device, a smart lawn mower, and so on. More generally, the electronic device may be a constrained-resource device, but which has the minimum hardware capabilities to use a trained generative ML model. The electronic device may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge, smart vacuum cleaner, smart lawn mower, smart oven, etc). It will be understood that this is a non-exhaustive and non-limiting list of example devices.

In an aspect of the present techniques, there may be provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g., Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the operations of the above-described method.

The method described above may be wholly or partly performed on an apparatus, e.g., an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Broadly speaking, embodiments of the present techniques provide a method for adapting trained generative machine learning, ML, models to produce high-quality and high-resolution images, even when the models were trained using training images of a lower resolution. The generative model may be any diffusion-based model.

Generally speaking, image generation may be based on a user-provided description of the desired content of the image, typically expressed in natural language (referred to as a “text prompt”). While the present techniques seek to improve the image generation process, but they can also be applied to other image generation technologies, such as image inpainting, image editing or image restoration. The present techniques may assume that an image generation model (diffusion model) exists on a user electronic device (e.g., smartphone, tablet or laptop), which the user can directly access in order to generate images. It will be understood that the present techniques can also operate on servers, e.g., where an image generation model runs on a server and is communicatively coupled to a user device (which provides text prompts and receives the generated images). In any case, such models may typically be trained to generate images at specific resolutions. The present techniques may extend the abilities of such an existing model to operate at flexible resolutions, e.g., at higher resolutions and/or different aspect ratios than those for which it was trained.

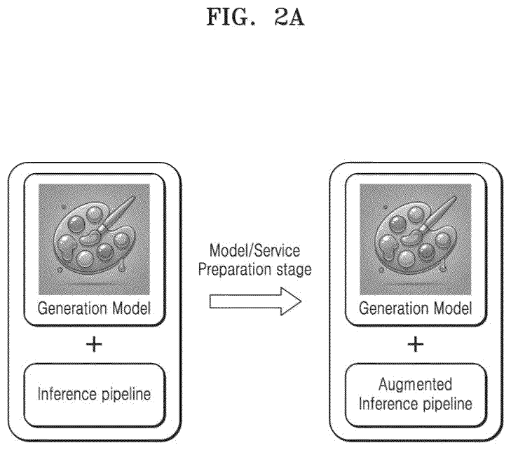

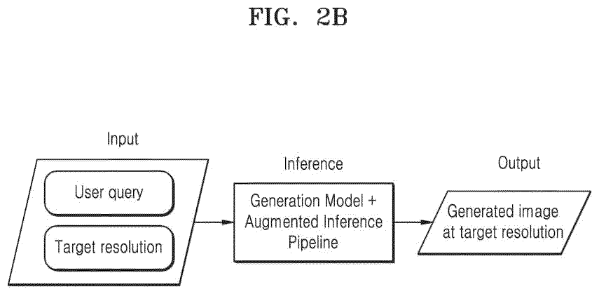

FIG. 2A illustrates a block diagram illustrating how image generation models operate (left), and how the present techniques adapt the capabilities of models at inference time (right) according to an embodiment of the disclosure. As mentioned above, it may be assumed that the electronic device already has an image generation model (text-to-image) stored on it for use by a user. The image generation model may be trained to output images within a training resolution range. The present techniques advantageously do not require any changes to the image generation model to be made. Instead, the image generation model may be adapted for higher resolutions by simply applying change to the inference-time code, e.g., how the model is used at inference time to generate an image in response to a user-input text prompt. The result of the present techniques may be that the model is able to generate images at resolutions beyond the training resolution range, e.g., 2× the previous maximum resolution.

FIG. 2B illustrates a simplified flowchart of example operations to implement the present techniques according to an embodiment of the disclosure. As shown, the present techniques may involve receiving a user query to generate an image (e.g., a text prompt), and a target resolution for the image. The present techniques may utilise the trained generative ML model together with an augmented inference pipeline to generate the image according to the text prompt and the required target resolution. The generated image may then be output for the user.

Diffusion models may be proficient at generating high-quality images. As explained above, they are however effective only when operating at the resolution used during training. Inference at a scaled resolution may lead to repetitive patterns and structural distortions. Retraining at higher resolutions quickly becomes prohibitive. Thus, methods enabling diffusion models to operate at flexible test-time resolutions are highly desirable. Previous works suffer from frequent artifacts and often introduce large latency overheads. The present techniques may provide two simple modules that combine to solve these issues. Firstly, a Frequency Modulation (FM) module may be introduced, which may leverage the Fourier domain to improve the global structure consistency. Secondly, an Attention Modulation (AM) module may be introduced, which may improve the consistency of local texture patterns, a problem largely ignored in prior works. The present techniques, coined “FAM diffusion”, can seamlessly integrate into any latent diffusion model and requires no additional training. Extensive qualitative results highlight the effectiveness of the present method in addressing structural and local artifacts, while quantitative results show state-of-the-art performance. Also, the present method may avoid redundant inference tricks for improved consistency such as patch-based or progressive generation, leading to negligible latency overheads.

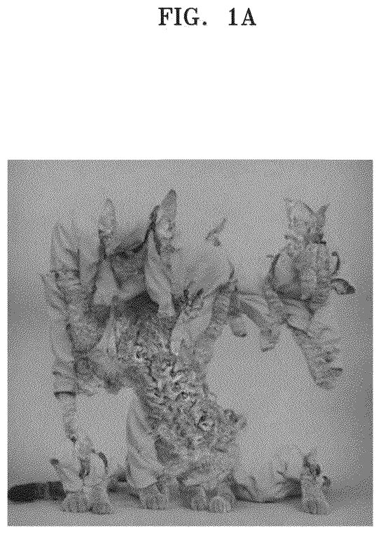

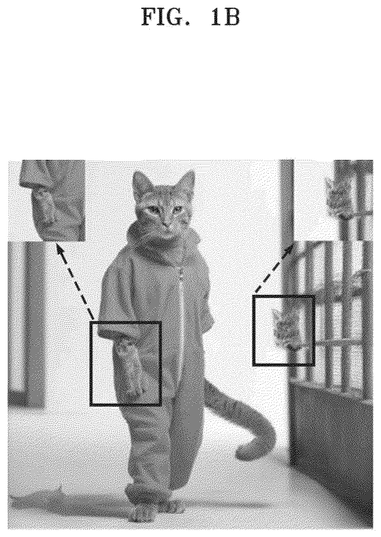

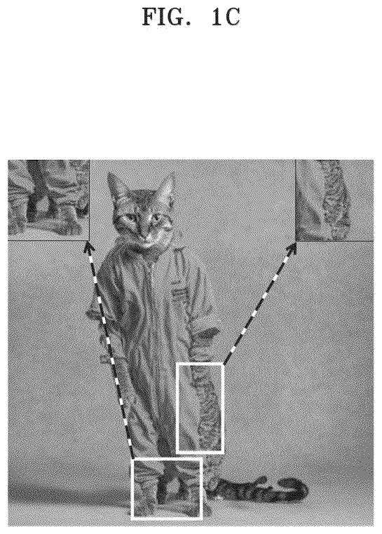

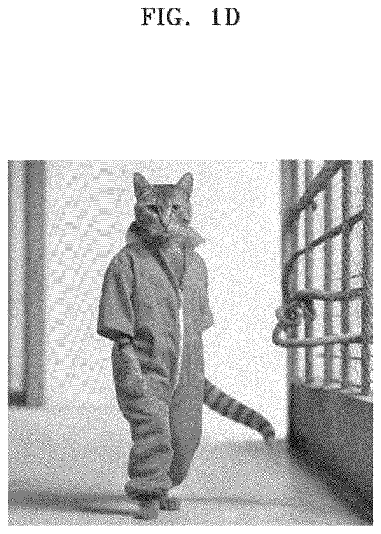

FIGS. 1A to 1C illustrate the limitations of related techniques to generate high resolution images according to an embodiment of the disclosure, as explained above. Specifically, FIGS. 1A to 1C show comparisons of high resolution image generation at 3× the native/initial resolution of a generative model using, respectively, Direct Inference, DemoFusion, and HiDiffusion generative models. To address these limitations, the present techniques may provide a straightforward yet effective approach that takes the best of both worlds. The present method may follow the single pass generation strategy for improved latency but, like patch-based approaches, leverage the native resolution generation to steer the high-resolution one. Specifically, the present method may start by generating an image at native resolution conditioned on the input text prompt. Then, the method may resort to a test-time diffuse-denoise strategy, where the high-resolution denoising stage is guided by the native resolution diffusion process. However, instead of blindly steering the high-res image toward the low-res one as done elsewhere, the present techniques propose a Frequency Modulation (FM) module. In particular, the Fourier domain may be leveraged to selectively condition low-frequency components during the high-resolution image generation stage, while providing full control over high-frequency components to the denoising process.

While the FM module resolves artifacts related to global consistency, artifacts related to inconsistent local texture might still be present, e.g., finer texture generated on semantically related parts of the image might be inconsistent. To tackle this second issue, largely ignored in the literature, the present techniques propose an Attention Modulation (AM) mechanism that may leverage attention maps from the denoising process at native resolution to condition the attention maps of the denoising process at high resolution. Since attention maps at native resolution encode which regions of the image are semantically related, they may regularize the high-res denoising towards consistent finer texture generation. The present method, coined Frequency and Attention Modulated diffusion (FAM diffusion), may combine the FM and AM modules to yield superior quality results, as shown in FIG. 1D.

Advantageously, the present method may seamlessly integrate with any latent diffusion model without additional training or architectural changes. It is empirically shown that the present method significantly enhances the quality and efficiency of high-resolution image generation, establishing a new state-of-the-art.

Prior to explaining the details of the present techniques in detail, a brief overview of some related techniques is provided for context.

### Related Works

Diffusion models have shown impressive performance in generating creative and accurate representations given text prompts. While early work was limited to generating relatively low-resolution images (e.g., 256×256), follow-up work showed that their performance can scale to higher resolutions, e.g., 512×512 with SD1.5 and 1024×1024 with SDXL. However, a major shortcoming with all these models is that generation remains limited by the resolution used at training time. Naively targeting higher train-time resolutions quickly results in prohibitive training costs and computational requirements, and the limited availability of high-resolution training data also restricts the diversity of image generation. Thus, adapting pre-trained diffusion models to generate high-resolution images without retraining has emerged as a topic of interest.

Early works proposed using overlapping patches at native resolution and blending the outputs to produce an image without seams. However, this leads to frequent repetitions and inconsistent global image structure. Therefore, subsequent works introduced various mechanisms to encourage global structural consistency. For instance, DemoFusion proposed a patch-based generation process with mechanisms such as skip residuals and progressive upsampling, while AccDiffusion used localized prompting to guide high-resolution generation and improve consistency with images generated at native resolutions. However, these methods still suffer from issues like local repetitions, and inconsistent global coherence. They also have significant latency overheads due to the running cost of multiple backward passes. To mitigate the high latencies, other works aim to generate high-resolution images in a single pass by modifying the architecture of the UNet. For example, one technique employs dilated convolutions to adjust the receptive field of convolutions in the denoising UNet. HiDiffusion introduces an alternative UNet that dynamically adjusts the feature map size during the denoising process. While these approaches achieve faster generation, they often result in image distortions.

More closely related to the present techniques are methods that have approached structural consistency from a frequency domain perspective. FouriScale splits the image in Fourier domain, then proceeds to incorporate a low-pass filtering operation and impose structural consistency with an image generated at native resolution. However, this splitting operation results in unrealistic images. Others decompose images into spatial frequency components conditioned on local and global prompts, but these often rely on redundant operations that lead to high latencies. Others leverage low-frequency information from the latent representation of the native image to provide desirable global semantics during the denoising process. However, these ignore the noise distribution differences between the current high-resolution denoising step and the native image in latent space. In addition, they still rely on patch-based denoising, making it inefficient. In contrast to these methods, the present techniques provide a one-pass method that does not alter the model architecture. Importantly, the present method introduces a complementary novel attention modulation mechanism, which targets local structure consistency; an issue overlooked by all related works.

### Method

The present techniques may leverage pretrained latent diffusion models (LDMs), which have been extensively trained on large-scale high-quality data. The goal may be to generate images at higher resolutions than the resolutions used during training, without any additional finetuning or model modification.

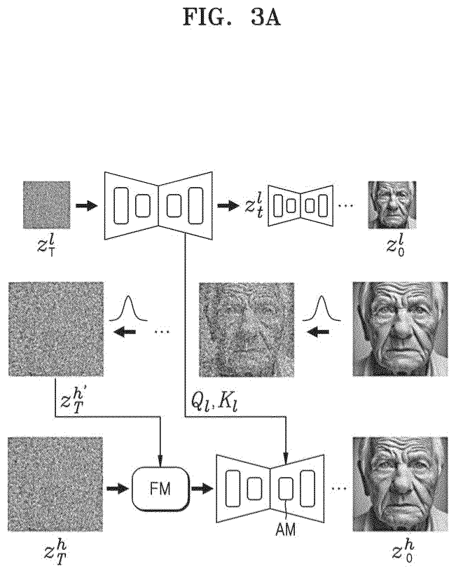

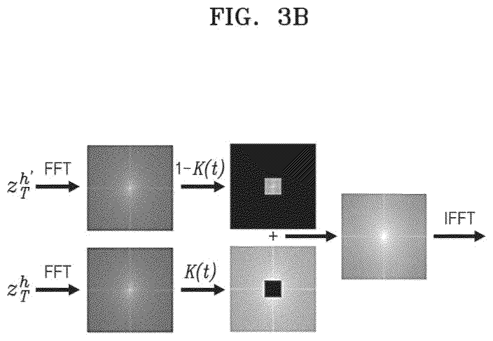

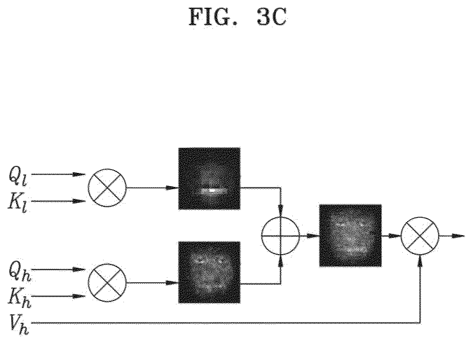

FIGS. 3A to 3C illustrate schematic diagrams showing overviews of the FAM diffusion method of the present techniques according to an embodiment of the disclosure. Specifically, FIG. 3A shows how the present techniques involve first generating an image at native resolution, followed by a test-time diffuse-denoise process. The present techniques may incorporate the Frequency Modulation module and Attention Modulation module during high-resolution denoising to control global structure and fine local texture, respectively. FIG. 3B shows details of the Frequency Modulation, where the Fourier domain may be used to selectively condition low-frequency components during high-resolution denoising while leaving high-frequency components fully controllable. FIG. 3C shows details of the Attention Modulation module, where attention maps from the native image denoising may be used to correct the high-resolution denoising. FAM diffusion is described in more detail below.

### Preliminaries

Latent Diffusion Models (LDM): The present techniques may operate in the realm of LDMs, which first convert image x₀ to a latent representation z₀ using an encoder such that z₀=ε(x₀), z₀∈ [symbol] . During training, a Markovian diffusion process progressively adds noise to the input latent z₀ according to a defined (e.g., predefined, predetermined) schedule βₜ, t∈[1, T] by sampling sequentially from:

$$q ( {z}_{t} \vert {z}_{t - 1} ) := 𝒩 ( {z}_{t} \vert \sqrt{1 - {β}_{t}} {z}_{t - 1} , {β}_{t} I ) \qquad ( Equation 1 )$$

Conversely, a trainable denoising process progressively recovers the original latent z₀ using a noise estimator [symbol] =(μ_{θ}, Σ_{θ}) parametrized by θ by sampling from:

$${p}_{θ} ( {z}_{t - 1} \vert {z}_{t} ) := 𝒩 ( {z}_{t - 1} \vert {μ}_{θ} ( {z}_{t} , t ) , {\sum }_{θ} ( {Z}_{r} , t ) ) \qquad ( Equation 2 )$$

During inference, an image may be generated by denoising from random noise, z_{T}˜ [symbol] (0, I)∈ [symbol] , through sequential calls to [symbol] . The quality of the generated image may

improve with the number of operations to finally yield the latent representation

$${z}_{0}^{n} ∈ {ℝ}^{c \times h \times w} ,$$

where we introduce the superscript n to indicates generation at native resolution h×w (e.g., same as training resolution).

Inference-time diffuse-denoise: The present goal may be to use the pretrained parametric denoiser z_{θ}, without further finetuning, to generate

$${z}_{0}^{m} ∈ {ℝ}^{c \times s h \times s w}$$

at a higher resolution m, m=sh×sw, where s may be the target resolution scaling factor. The naïve approach may be to directly start from random noise at the target resolution,

$${z}_{T}^{m} ∼ 𝒩 ( 0 , I ) ∈ {ℝ}^{c \times s h \times s w} .$$

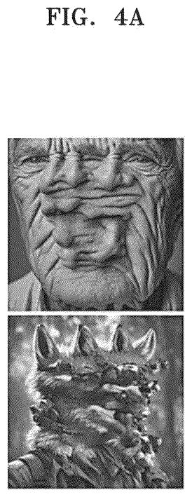

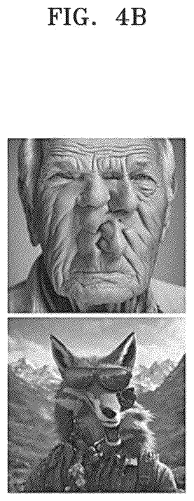

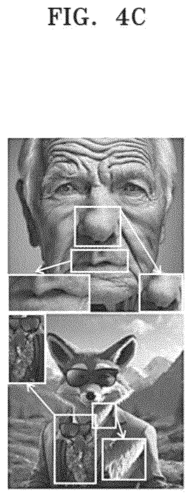

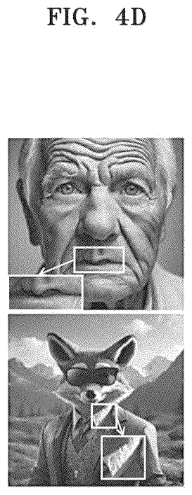

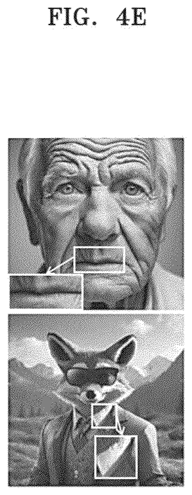

However, this has been repeatedly shown to lead to suboptimal results, with frequent artifacts and object duplication, as illustrated in FIGS. 4A to 4C.

FIGS. 4A to 4E illustrate ablation on the components of FAM diffusion according to an embodiment of the disclosure. Specifically, FIG. 4A illustrates Direct Inference (DI) at high resolution from noise, FIG. 4B illustrates Direct Inference from low-res latent (DI*), FIG. 4C illustrates Skip Residual (SR) from DemoFusion, FIG. 4D illustrates the present Frequency Modulation (FM) process, and FIG. 4E illustrates the present Frequency Modulation (FM) process combined with Attention Modulation (AM).

Related works proposed a test time diffuse-denoise process. The idea is to start from the output of the denoising process at native resolution,

$${z}_{0}^{n}$$

rather than noise, which is then upsampled to the target resolution m to obtain

$${\tilde{z}}_{0}^{m} = 𝒰 ( {z}_{0}^{n} , s ) ,$$

where [symbol] denotes an upsampling function. Next, T forward diffusion operations progressively add noise to the latents

$${\tilde{z}}_{t = 1 … T}^{m} .$$

Finally, the backward process denoises from

$${\tilde{z}}_{T}^{m}$$

to yield the final output

$${z}_{0}^{m} .$$

Note that \tilde{z} and z are used to refer to the latents generated during diffusion and denoising, respectively.

While a standard denoising process as in Eq. 2 could be used, it often leads to inconsistent global structures, as shown in FIG. 4B. Instead, the denoising process from Eq. 2 is now defined as:

$${p}_{θ} ( {z}_{t - 1}^{m} \vert {f}_{t} ( {\tilde{z}}_{t}^{m} , {z}_{t}^{m} ) ) \qquad ( Equation 3 )$$

where ƒₜ(.) may be tasked with steering the denoising process and improving the consistency between the high-res and low-res images. Previous work define ƒₜ(.) as a simple weighted linear combination of

$${\tilde{z}}_{t}^{m} and {z}_{t}^{m}$$

and coin the mechanism skip residual. It is shown in FIG. 4C that this yields to suboptimal results. In contrast, the present techniques propose a Frequency Modulated approach to defining ƒₜ(.).

Before explaining FM and AM in more detail, the general principles of the present techniques are explained.

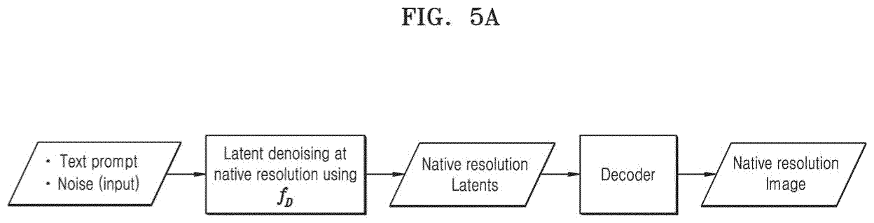

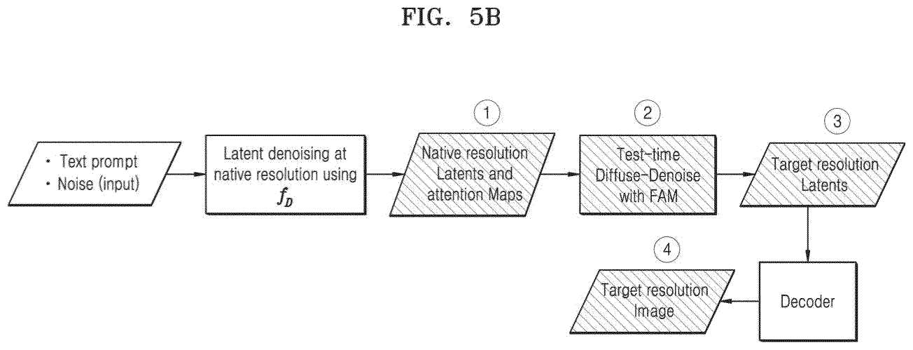

FIG. 5A illustrates a standard text-to-image generation pipeline according to an embodiment of the disclosure, which provides some context for understanding the present techniques. As shown, the inputs into a pre-existing diffusion model ƒ_{D} includes a text prompt for a specific image to be generated (which comes from a user) and a noisy starting image which will be denoised to generate an image, as per the standard diffusion process. The model then denoises the noisy starting image at a native resolution of the model. Rather than operating on the image itself, the model operates on latent representations. The model then generates a final latent representation at the native resolution. This final latent representation is passed into a decoder, which converts the representation into the final generated image at the native representation.

FIG. 5B illustrates a modified text-to-image generation pipeline for the FAM diffusion process of the present techniques according to an embodiment of the disclosure. It can be seen that the first two stages may be the same as in FIG. 5A, and so are not repeated. However, the present techniques may generate the latent representations at the native resolution as well as attention maps (explained below), as shown at operation 1. The present techniques may then perform a diffuse-denoise process at the higher, target resolution (operation 2). The result may be the generation of a final latent representation at the required higher target resolution (operation 3). This final latent representation may be passed into a decoder, which may convert the representation into the final generated image at the higher representation.

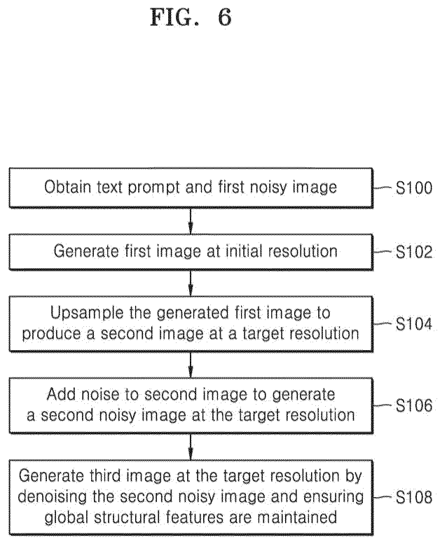

FIG. 6 illustrates a flowchart of example operations for generating high-resolution images using a pre-existing trained diffusion-based generative machine learning, ML, model according to an embodiment of the disclosure. The method for adapting a trained generative ML model may comprise: obtaining a text prompt to generate an image, and a first noisy image (operation S100). This is similar to what is described above with respect to FIGS. 5A and 5B.

The method may then comprise: generating a first image according to the text prompt and at an initial resolution, by denoising the first noisy image using the trained generative ML model over a plurality of first denoising timesteps, wherein the trained generative ML model may have been trained using images having the initial resolution (Operation S102). Again, this is described above with respect to FIGS. 5A and 5B.

The method may then comprise: upsampling, using an upsampling module, the generated first image to produce a second image having a target resolution, wherein the target resolution may be higher than the initial resolution (operation S104). The upsampling may cause a higher resolution to be generated, but the resulting second image is not itself be of high enough quality, which is why simply upsampling the image is not sufficient to produce a high quality and high resolution image using a diffusion model. Any upsampling technique may be used, such as bicubic upsampling.

The method may comprise: adding noise to the second image using the trained generative ML model over a plurality of noising timesteps, to generate a second noisy image at the target resolution (operation S106). Thus, the present techniques may initiate a diffusion process to convert the second image into a second noisy image. This may be achieved by: adding noise to a latent representation of the second image generated at a previous noising timestep; and storing the noised latent representation.

The method may comprise: generating a third image at the target resolution (operation S108) using a second denoising process. This may be achieved by: denoising the second noisy image using the trained generative ML model over a plurality of second denoising timesteps, wherein each second denoising timestep may correspond to a noising timestep, and during each second denoising timestep, ensuring global structural features in the second image are maintained, wherein the global structural features may be obtained from the stored noised latent representation for the corresponding noising timestep. How the global structural features are maintained is now described in more detail below in relation to the Frequency Modulation.

Frequency-Modulated Denoising: The conditioning of the denoising operations through the skip residual may have been shown to improve consistency between low and high-resolution images. However, it may be observed that it lacks control over the information transferred. More specifically, the goal of the test-time diffuse-denoise process may be to take the upsampled low-resolution image and to produce an output that 1) preserves the global structure, and 2) improves the texture and high-frequency details. The skip residual mechanism however steers the output towards the input indiscriminately, which serves the first objective but can negatively impact the latter. It would be desirable to instead harness the global structure information from the diffused latents of the forward process, while allowing the denoising process to handle the generation of details. To this end, the present techniques appeal to the frequency domain, where global structure and finer details are captured by low- and high-frequency, respectively, and re-define the function ƒₜ(.), which controls information transfer from the forward diffusion into the denoising process.

Let K(t) be a high-pass filter for timestep t, the function ƒₜ(.) in Eq. 3 is defined as follows:

$${f}_{t} ( {\tilde{z}}_{t}^{m} , {z}_{t}^{m} ) = {IDFT}_{2 D} ( 𝒦 ( t ) ⊙ {DFT}_{2 D} ( {z}_{t}^{m} ) + ( 1 - 𝒦 ( t ) ⊙ {DFT}_{2 D} ( {\tilde{z}}_{t}^{m} ) ) , \qquad ( Equation 4 )$$

where ⊙ may denote the Hadamard product. Essentially, the high-frequency coefficients of the denoised latent

$${z}_{t}^{m}$$

may be combined with the low-frequency coefficients of the diffused latent

$${\tilde{z}}_{t}^{m} ,$$

modulated by the filter K(t). Eq. 4 can be further reformulated in the time domain as below:

$${f}_{t} ( {\tilde{z}}_{t}^{m} , {z}_{t}^{m} ) = {z}_{t}^{m} + κ ( t ) ( {\tilde{z}}_{t}^{m} - {z}_{t}^{m} ) , \qquad ( Equation 5 )$$

where κ(t)=IDFT_{2D}(1− [symbol] (t)∈ [symbol] may be a convolutional kernel, and ⊙ may denote the circular convolution operator. Eq. 5 may show that the frequency modulation adds a low-frequency update to the denoised latent

$${z}_{t}^{m}$$

directed towards the diffused latent

$${\tilde{z}}_{t}^{m} ,$$

subsequently preserving the global structural information from the upsampled latent. Furthermore, the circular convolution [symbol] (t) in Eq. 5 can be interpreted as an additional (non-learnable) convolutional layer of the UNet, effectively providing it with a global receptive field and helping generate consistent structure without modifying the UNet architecture or using dilated sampling. The result of the present FM approach is shown in FIG. 4D. In comparison, the skip residual approach of DemoFusion, shown in FIG. 4C, produces inconsistencies like a missing left nostril and unnaturally small eyes.

More specifically, the present techniques may rely on the frequency domain and use a high pass filter to steer the denoising process as described in Eq. 4. In the following, the formal definition of the time-varying high pass filter, [symbol] (t), that is used is provided.

The high-pass filters [symbol] (t) have time-varying cut-off frequencies, defined as follows:

$$ρ ( t ) = \frac{t}{T} \qquad ( A1 )$$

$${τ}_{h} ( t ) = h \cdot c \cdot ( 1 - ρ ( t ) ) \qquad ( A2 )$$

$${τ}_{w} ( t ) = w \cdot c \cdot ( 1 - ρ ( t ) ) \qquad ( A3 )$$

where τₕ(t) and τ_{w}(t) may be the horizontal and vertical cut-off frequencies at timestep t, respectively. Subsequently, the mask [symbol] (t), which is applied on the shifted frequency spectrum centered on (x_{c}, y_{c}), is defined as

$$𝒦 ( t ) = \{ \begin{matrix}ρ ( t ) , & if \vert x - {x}_{c} \vert < \frac{{τ}_{w} ( t )}{2} \& \vert y - {y}_{c} \vert < \frac{{τ}_{h} ( t )}{2} \\ 1 , & otherwise\end{matrix} , \qquad ( A4 )$$

The cut-off frequency may grow as the denoising process progresses, while the scaling factor of the low-frequency coefficients decreases. The present frequency modulation may be designed such that the guidance from the denoised latent \tilde{z}ₜ becomes more significant as t→0. In the experiments, c=0.5 is used.

Derivation of the Frequency Modulation in time-domain: As noted above, the frequency modulation introduced in Eq. 4 can be reformulated in time domain as Eq. 5, and the corresponding benefits are also noted. Here, a formal derivation to support the equivalence between the two formulations is provided. For ease of presentation, the timestep t and resolution m notations may be omitted from operands.

Let z∈ [symbol] be the 2D latent, and Z=DFT_{2D}(z)∈ [symbol] be the Fourier transform of z. Written in matrix form,

$$Z = ( {W}_{r} z {W}_{t} ) , \qquad ( A5 )$$

where Wᵣ∈ [symbol] , W_{c}∈ [symbol] may be the row- and column-wise Fourier transform matrices, respectively. Let [symbol] ∈ [symbol] be the high-pass filter defined above, such that the proposed mixing operation in the frequency domain is formulated as below:

$$\begin{matrix}\hat{Z} & = 𝒦 ⊙ {DFT}_{2 D} ( z ) + ( 1 - 𝒦 ) ⊙ {DFT}_{2 D} ( \tilde{z} ) \\ & = 𝒦 ⊙ ( {W}_{r} z {W}_{c} ) + ( 1 - 𝒦 ) ⊙ ( {W}_{r} \tilde{z} {W}_{c} ) \\ & = {W}_{r} z {W}_{c} + ( 1 - 𝒦 ) ⊙ ( {W}_{r} ( \tilde{z} - z ) {W}_{c} )\end{matrix}$$

The inverse DFT of \hat{Z}, which is the outcome of Eq. 4, is formulated as:

$$\begin{matrix}\hat{z} & = {IDFT}_{2 D} ( \hat{Z} ) \\ & = {W}_{r}^{- 1} ( {W}_{r} z {W}_{c} + ( 1 - 𝒦 ) ⊙ ( {W}_{r} ( \tilde{z} - z ) {W}_{c} ) ) {W}_{c}^{- 1} \\ & = {W}_{r}^{- 1} {W}_{r} z {W}_{c} {W}_{c}^{- 1} + {W}_{r}^{- 1} ( ( 1 - 𝒦 ) ⊙ ( {W}_{r} ( \tilde{z} - z ) {W}_{c} ) ) {W}_{c}^{- 1} \\ & = z + ( {W}_{r}^{- 1} ( 1 - 𝒦 ) {W}_{c}^{- 1} ) ( {W}_{r}^{- 1} {W}_{r} ( \tilde{z} - z ) {W}_{c} {W}_{c}^{- 1} ) \\ & = z + k ( \tilde{z} - z )\end{matrix}$$

resulting in Eq. 5 above, where

$$k = {W}_{r}^{- 1} ( 1 - K ) {W}_{c}^{- 1} = {IDFT}_{2 D} ( 1 - 𝒦 )$$

may be a convolutional kernel and [symbol] may denote a circular convolution operator.

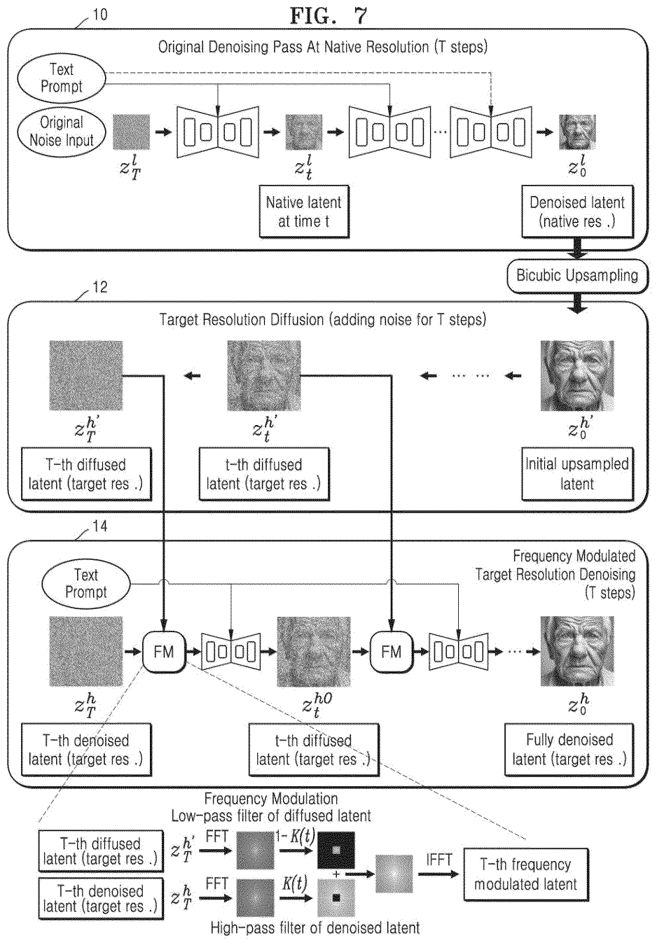

FIG. 7 illustrates a schematic diagram illustrating the Frequency Modulation (FM) process according to an embodiment of the disclosure. In block 10 of FIG. 7, the ordinary denoising process at the native resolution may be performed, as described above with reference to, for example, FIGS. 5A and 6. At the end of block 10, the first image may have been generated over T first denoising timesteps, at the native resolution of the model. This may then be upsampled, as explained with reference to FIG. 6 above, to generate a second image at the higher target resolution.

Block 12 of FIG. 7 illustrates the diffusion or noising process during which noise is added to the second image to generate a noisy second image. The diffusion process takes place over T noising timesteps. The result may be the generation of a second noisy image, which differs from the first noisy image by being at the higher target resolution.

Block 14 of FIG. 7 illustrates the second denoising process, at the higher target resolution. The second denoising process may occur over T second denoising timesteps, and may result in a third image which is fully denoised and at the higher target resolution. During this second denoising process, the present Frequency Modulation module may be used to control global structure. The FM module may ensure global structure consistency is maintained (fixed) between the third image and the first image, while allowing higher fidelity details to be generated appropriately. In other words, the first image may be generated at a native resolution and the third image may be generated at a higher resolution, which may be twice as big, but the model may need to know how to fill all the additional pixels of the third image. The FM module may ensure that the structure of the first image is present in the third image (e.g., the man has only two eyes, one nose, one mouth, etc. in both the first image and the third image) but allow the model to decide how to fill in any blank pixels within this structure.

Thus, operation S108 in FIG. 6, to generate the third image may comprise, at each second denoising timestep of the plurality of second denoising timesteps, the following further operations: generating, using a frequency modulation module, a frequency-modulated version of the second noisy image, wherein the frequency modulation module may ensure global structural features are maintained; and inputting the frequency-modulated version of the second noisy image into the trained generative ML model for denoising. This can be seen in FIG. 7 block 14: at each time step, the latent representation may be input into the FM module prior to being input into the model. The frequency modulation, FM, module may be any module, function or routine which is able to produce a frequency-modulated version of the second noisy image. In this way, the FM module may control what is input into the trained generative ML model during the second denoising operations, and therefore, help to ensure that global structural features are maintained during the second denoising.

Specifically, at each second denoising timestep, the operation S108 of generating a frequency-modulated version of the second noisy image may comprise: inputting the stored noised latent representation of the corresponding noising timestep and the denoised latent representation of the second denoising timestep into the frequency modulation, FM, module. To enable the FM module to maintain global structural features, it may need to know what these features are. Therefore, prior to each second denoising timestep, the FM module may be given the stored noised latent representation from the corresponding noising timestep because this may include the global structural features from the upsampled second image. (This can be seen in block 14 of FIG. 7, since the FM may receive two inputs at each timestep—one from block 14 and one from block 12.) This is because the second image may be generated by simply upsampling the first image, and so maintain the structural information (local and global). The FM module may also be given the denoised latent representation, so that the FM module can effectively affect how the trained ML model denoises the denoised latent representation to ensure the global structural information is maintained during the denoising. It may be important that the two inputs into the FM module correspond to the same timesteps to ensure that the denoising occurs smoothly. That is, the T-th noised latent representation may be input together with the T-th denoised latent representation.

As noted above, the way the FM module works may be by operating in the frequency domain. This is now explained in more detail.

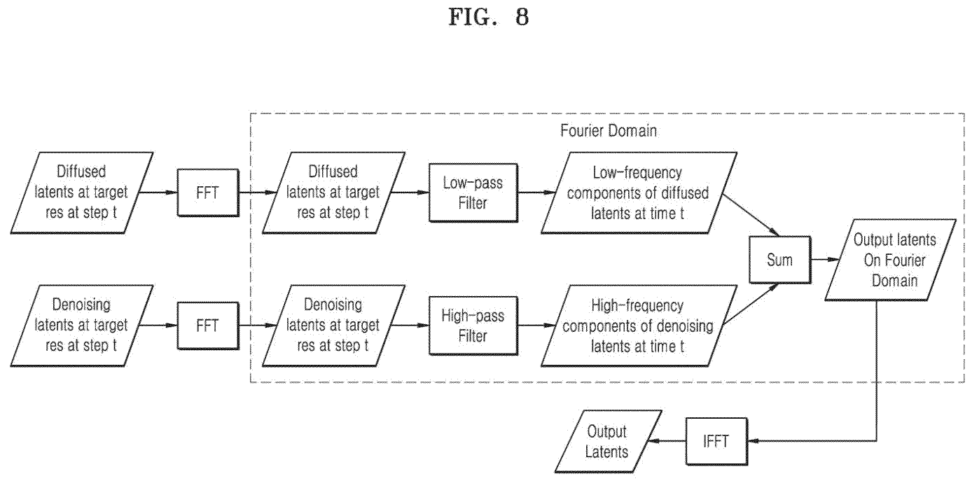

FIG. 8 illustrates a block diagram showing example operations for generating a frequency-modulated version of a latent representation during each second denoising timestep according to an embodiment of the disclosure.

As shown in the top half of FIG. 8, at each second denoising timestep, generating a frequency-modulated version of the latent representation may comprise: applying a low-pass filter to the stored noised latent representation of the corresponding noising timestep, to retain low-frequency components of the stored noisy latent representation, wherein the low-frequency components may correspond to global structural features in the second image. The low-pass filter may be part of the FM module and may be applied to the stored noisy latent representation (obtained from the second image). The low-pass filter may be used to identify the low-frequency components (effectively of the second image), so that these components can be maintained during the current second denoising timestep by the trained ML model.

As shown in the bottom half of FIG. 8, at each second denoising timestep, generating a frequency-modulated version of the latent representation may comprise: applying a high-pass filter to the denoised latent representation of the second denoising timestep, to retain high-frequency components of the denoised latent representation, wherein the high-frequency components may correspond to local structural features in the second image. The high-pass filter may be part of the FM module and may be applied to the denoised latent representation that is to be processed by the trained ML model during the current second denoising timestep. The high-pass filter may be used to identify the high-frequency components (effectively from the previous denoising operation), so that these components can be maintained during the current second denoising timestep by the trained ML model. In other words, it may be desirable to maintain the high-frequency components generated during the previous denoising operation in the current denoising operation, because these have been generated by the trained ML model during the denoising and are likely important local structural features. Thus, these high-frequency components from the denoising may be maintained as well as the low-frequency components from the noising process.

The high-pass filter may be used to retain local structural features such as, for example: colour information; texture information; pattern information. It will be understood that these are non-limiting examples of local structural features. As explained above, broadly speaking, local structural features may be high frequency features which change across an image and are likely to disappear if the image were downsized or made blurry. For example, the colour green of a football field in an image may remain in an image if it were downsized, but the texture of the field (e.g., the blades of grass) may be lost.

As shown by the “sum” box in FIG. 8, at each second denoising timestep, generating a frequency-modulated version of the latent representation may comprise: combining the retained low-frequency components of the stored noised latent representation and the retained high-frequency components of the denoised latent representation, to generate the frequency-modulated version of the latent representation of the second noisy image. Thus, to ensure that the high-frequency components generated during the previous denoising operation and the low-frequency components from the noising process are maintained, the retained components may be combined, such as by summing.

For example, prior to generating a frequency-modulated version of the second noisy image, the method may comprise: converting, using a Fast Fourier Transform, FFT, the stored noised latent representation of the corresponding noising timestep and the denoised latent representation of the second denoising timestep into a Fourier domain. This is shown by the “FFT” blocks performed prior to operating in the Fourier domain (dashed region in FIG. 8). An FFT may be an algorithm for converting a signal from its original domain (e.g., image/pixel space) to a representation in the frequency domain. this may help to perform the frequency modulation operations, as the high and low frequency components (e.g., local and global structural information) are more easily discernible in the frequency domain than in the original domain.

For example, prior to inputting the frequency-modulated version of the second noisy image into the trained generative ML model for denoising, the method may comprise: applying an inverse Fast Fourier Transform, iFFT, to the generated frequency-modulated version of the latent representation of the second noisy image. This is shown by the “iFFT” block that follows the processing in the Fourier domain. Thus, the reverse of the FFT process may be performed to convert the summed components back into a form that the trained ML model is able to understand. The resulting frequency-modulated version of the second noisy image (e.g., latent representation) may then be suitable for input into the diffusion model to generate the next latent representation via denoising, for the next timestep.

As mentioned above, the FM module may ensure that global structural features are maintained between the noising and second denoising processes (e.g., number of footballs). The FM module may also ensure that local structural features are maintained between timesteps of the second denoising process (e.g., colour, shape and texture of the football). However, the trained ML model may not understand how those local structural features fit in with the global structural features (e.g., whether the colour of the football only applies to the football or also to the boy). Thus, to ensure that the local structural features and global structural features are correctly merged in the generated third image, it may be necessary to control where the trained ML model adds the local structural features in the third image. To do this, the present techniques may utilise an attention modulation, AM, module. The attention modulation, AM, module may be any module, function or routine which is able to cause the trained ML model to pay attention to where the local structural features should appear in the third image.

Attention Modulation: While the FM module successfully maintains global structure and solves the issue of object duplication as shown in FIG. 4D, it may be noted that local structures can be inconsistently generated due to the discrepancy between training-time native resolution and the target inference-time high resolutions. For example, the top image in FIG. 4D may show a distorted mouth compared to the one at native resolution. Similarly, in the bottom example, fur texture may be incorrectly generated on the shirt collar. That is, the high-frequency detail generated on the shirt collar may be semantically related to one generated on the fox's face and not to the other parts of the shirt. It may be hypothesized that this stems from incorrect attention maps during the high-res denoising stage. This motivates the proposal for including Attention Modulation (AM) in the present techniques. Inspiration is taken from attention swapping, a recent method to combine information from two diffusion processes in a more localized manner, and the idea is extended to transfer local structural information from the denoising process at native resolution to the one at target resolution.

For example, the attention of an input tensor z may be computed by first projecting it linearly into a triplet of query, keys, and values, (Q, K, V), respectively, and the self-attention is computed as:

$$Att ( z ) = softmax ( \frac{Q {K}^{T}}{\sqrt{d}} ) V = M \cdot V \qquad ( Equation 6 )$$

where d may indicate the feature dimensionality, and M may be referred to as the attention matrix.

In the present techniques, the self-attention may be modified at specific layers of the UNet of the high-resolution denoising process to incorporate information from the attention maps of the native resolution as:

$${\overline{M}}^{m} = ( λ \cdot 𝒰 ( {M}^{n} , s ) + ( 1 - λ ) \cdot {M}^{m} ) \qquad ( Equation 7 )$$

where Mⁿ and M^{m} may be the attention matrices at native and target resolution respectively, λ may be a hyperparameter, and [symbol] may be an s-times upsampling function. The new attention matrix M̅^{m} may then be used instead of M^{m} during the high-res denoising process in Eq. 6.

Applying the present AM module at all layers of the UNet can lead to suboptimal performance due to over-regularization. Instead it is applied only for layers in up-blocks of the UNet, as they are known to preserve layout information better. Furthermore, experiments with AM at various stages were conducted and it was found that the highest benefit is at up block 0. Results shown in FIG. 4E demonstrate the benefit of the proposed AM module, particularly regarding better preservation of local structures such as the mouth and shirt collar, highlighted in the white boxes.

More specifically, Attention Modulation can be in practice implemented as:

$$\begin{matrix}{z}^{′} & = ( λ \cdot 𝒰 ( {M}^{n} , s ) + ( 1 - λ ) \cdot {M}^{m} ) \cdot {V}_{m} \\ & = λ \cdot 𝒰 ( {M}^{n} \cdot 𝒟 ( {V}_{m} , s ) , s ) + ( 1 - λ ) \cdot {M}^{m} \cdot V \\ & = λ \cdot 𝒰 ( Att ( {Q}_{n} , {K}_{n} , 𝒟 ( {V}_{m} , s ) ) , s ) + ( 1 - λ ) \cdot Att ( {Q}_{m} , {K}_{m} , {V}_{m} )\end{matrix}$$

$$\begin{matrix}{z}^{′} & = ( λ \cdot 𝒰 ( {M}^{n} , s ) + ( 1 - λ ) \cdot {M}^{m} ) \cdot {V}_{m} \\ & = λ \cdot Att ( 𝒰 ( {Q}_{n} , s ) , 𝒰 ( {K}_{n} , s ) , {V}_{m} ) + ( 1 - λ ) \cdot Att ( {Q}_{m} , {K}_{m} , {V}_{m} )\end{matrix}$$

where [symbol] may denote an s-times upsampling function. Both attention operations can utilize Flash Attention. It may be noted that Flash Attention is available as a Triton kernel, hence a custom kernel supporting AM could be implemented by scaling the raw block-wise scores directly.

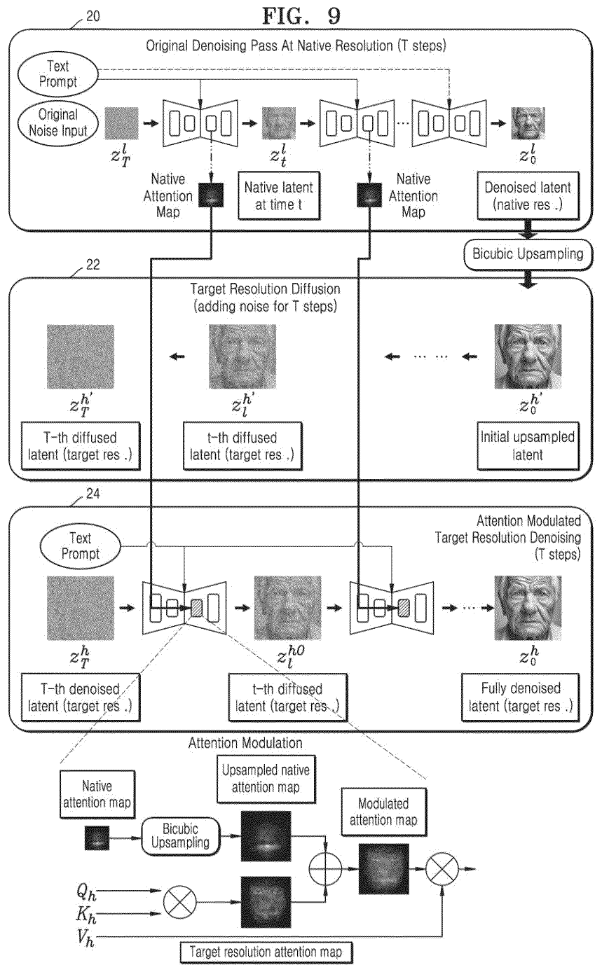

FIG. 9 illustrates a schematic diagram illustrating the Attention Modulation (AM) process. In block 20 of FIG. 9, the ordinary first denoising process at the native resolution may be performed. However, as mentioned with reference to FIG. 5B, when Attention Modulation is utilised, attention maps may also be generated during this first denoising process. As shown in block 20, at each first denoising timestep T, not only is a new latent representation generated by the model, but also an attention map is produced. Thus, the operation (S102 in FIG. 6) of generating the first image by denoising the first noisy image may comprise: generating, at each first denoising timestep, an attention map at the initial resolution, wherein each attention map may guide the trained generative ML model to focus on particular parts of the first noisy image; and storing the generated attention maps.

As shown at the bottom of FIG. 9, prior to storing (or prior to input into the AM process), the present method may further comprise: upsampling, using the upsampling module, the generated attention maps at the initial resolution to produce upsampled attention maps having the target resolution. This may ensure that the upsampled attention maps are useable by the attention modulation module, because they are of the right size/dimension.

Block 22 of FIG. 9 may be the same as block 12 of FIG. 7. No additional processing occurs during this first noising process in relation to Attention Modulation.

Block 24 of FIG. 9 illustrates how the Attention Modulation process is introduced during the second denoising process to ensure that fine local structure/texture is semantically correct. As shown in block 24, the AM process may use the attention maps generated during the first denoising process to correct the second denoising process. At each second denoising timestep of the plurality of denoising timesteps, the process of generating the third image may comprise: generating an attention map at the target resolution; and incorporating, using an attention modulation module, information from the stored upsampled attention map from a corresponding first denoising timestep into the generated attention map at the target resolution, to thereby transfer local structural features from the first image to the third image. That is, a new attention map may be generated by the attention modulation module, by performing attention on the second denoising latent representation prior to further processing by the trained ML model. Attention may be a standard process in diffusion models, and therefore, the attention process may effectively be modified so that information from the native resolution attention map is included when the attention at the high resolution is being performed by the ML model. Then, information from an upsampled attention map generated for a corresponding first denoising timestep may be incorporated into the new generated attention map, so that the new attention map may include the attention information from the original denoising process that was used to generate the first image. There may be multiple points within the denoising performed by the ML model where attention is performed. This may mean that the attention performed by layer L for the native resolution feeds into the attention performed by layer L for the high resolution, and so on.

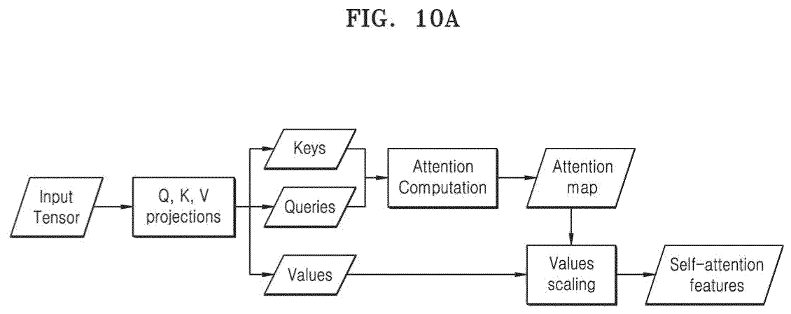

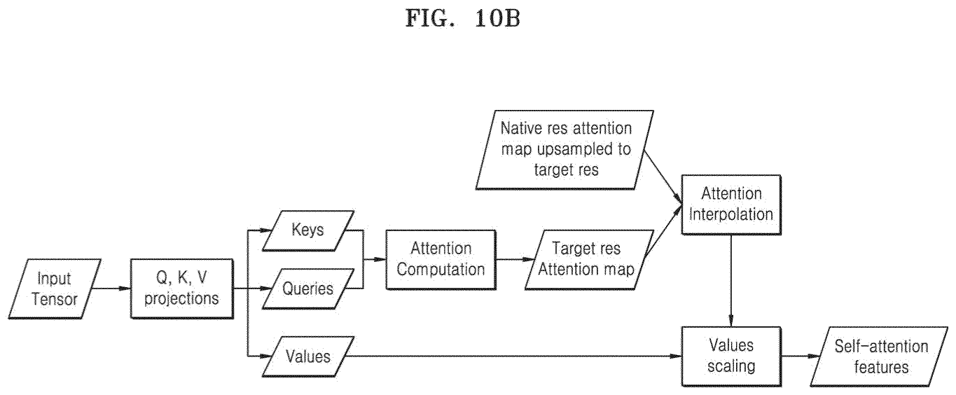

FIG. 10A illustrates a standard attention pipeline according to an embodiment of the disclosure, which provides some context for understanding the present techniques. As shown, an input tensor (e.g., a latent representation) may be used to generate query, key and values. The keys and queries may be used to generate an attention map, which is then used with the values to generate self-attention features.

FIG. 10B illustrates a modified attention pipeline for the FAM diffusion process of the present techniques according to an embodiment of the disclosure. As shown, the process may begin in the same way as the standard pipeline, but here, the attention maps from the first denoising process at the initial/native resolution may be used to condition or modify the attention maps generated during the second denoising process at the target resolution, to ensure that details appear in the third image in the right places/right contexts (e.g., are semantically correct).

### Experiments

### Experimental Setup

To demonstrate the effectiveness of the present aspect, the present aspect may be paired with a well-performing diffusion model like SDXL. For completeness, it may also be paired with the recent HiDiffusion, which specifically changes the attention mechanism of SDXL with windowed attention to improve the model latency. SDXL may be trained at 1024×1024 resolution, which is referred to herein as 1×. Experiments may be performed with three unseen higher resolutions such that the model generates 2×2, 3×3, and 4×4 times more pixels than the training setup. Additional experiments may be performed with various aspect ratios, e.g., 2×4.

### Evaluation Set

Following previous work, performance may be evaluated on a subset of the Laion-5B dataset. Given the number of compared methods and significant computational demands associated with the task, 10K images are randomly sampled from Laion-5b, which are used as the real images set, and 1K captions are sampled, which are used as text prompts for the models.

### Evaluation Metrics

Following prior work, the quality and diversity of the generated images may be evaluated using Frechet Inception Distance (FID) and Kernel Inception Distance (KID), computed between the generated and real images. Since FID requires resizing images to 299×299, which negatively impacts the assessment, it is typical to adopt their patch-level variants. Specifically, 10 random crops may be extracted from each image before calculating FID and KID, referring to these metrics as FID_{c} and KID_{c}. To further evaluate the semantic similarity between image features and text prompts, the CLIP score may be reported. To measure the efficiency of each method, latencies on a single A40 GPU may be computed.

### Main Results

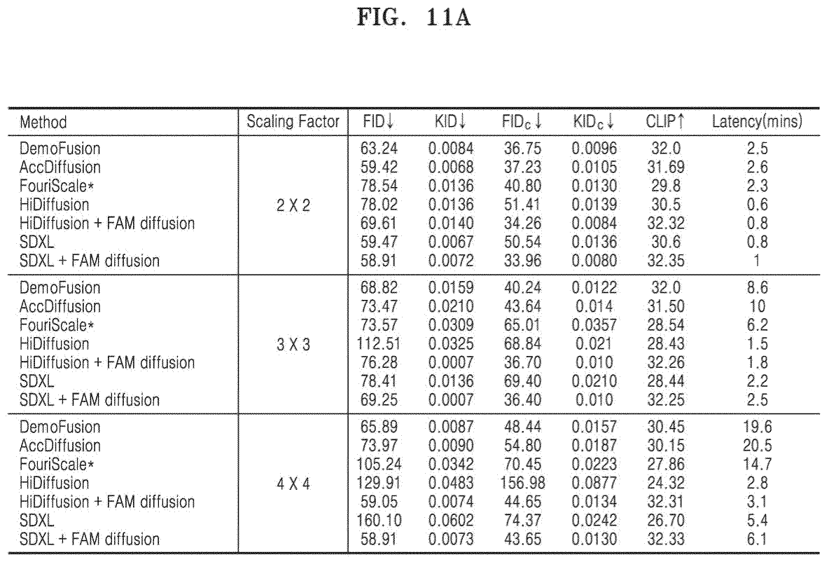

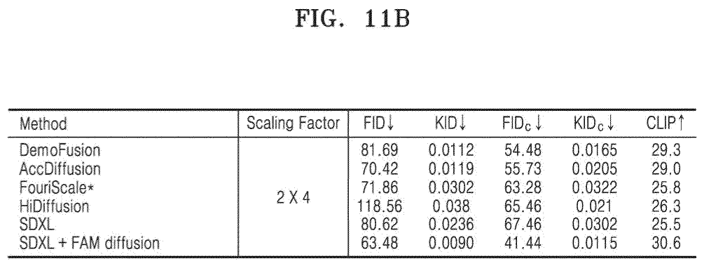

Demofusion, AccDiffusion, FouriScale, and HiDiffusion may be selected as representative methods of the current state-of-the-art among high-resolution generation methods. FIG. 11A illustrates a table showing results of system-level comparisons with SDXL according to an embodiment of the disclosure, where * may indicate inference with FreeU. As shown in FIG. 11A, the present techniques (FAM diffusion) may achieve the best overall performance on FID_{c}, KID_{c}, and CLIP Score in all cases. In the case of FID and KID, FAM diffusion may provide substantial gains for larger scale factors, while producing similar results to DemoFusion on lower scale factors. However, these metrics heavily downsample high-resolution images before computing the metrics and thus do not capture finer details in the evaluation results. This may be a widely-known issue for these metrics, as explained above. Finally, it may be noted that FAM diffusion adds only small latency overheads compared to direct inference on the target resolution, e.g., 0.2, 0.3, and 0.7 min at 2×, 3× and 4× scale factors respectively when combined with SDXL. In comparison, DemoFusion adds 14.2 sec latency vs SDXL direct inference at 4× scale factor. When compared to the frequency-based method FouriScale, FAM diffusion also shows notable improvements in both quality and latency. For instance, under 4K resolution image generation, it may achieve 43.65 vs. 70.45 on FID_{c} and 32.31 vs. 26.67 on CLIP score, while also being faster than FouriScale. Additionally, it may be observed that FAM diffusion can be seamlessly integrated into single-pass methods, such as HiDiffusion, to enhance performance while maintaining fast image generation, achieving an effective latency-quality trade-off. These results quantitatively validate the effectiveness of the present method in improving the quality of image generation.

FIG. 11B illustrates a table showing results of system-level comparisons with SDXL according to an embodiment of the disclosure, where * may indicate inference with FreeU. Here, the effect of using FAM diffusion to target different aspect ratios is studied. In particular, starting from the SDXL model, the present techniques may be used to targeting higher resolutions with different aspect ratios. The quantitative results in FIG. 11B clearly highlight the versatility of the present method that can seamlessly adapt to various settings without compromising quality.

### Ablation Study

In this section, ablation studies are conducted, using SDXL with the 2×2 scale factor setting.

Effectiveness of the components in the FAM diffusion: The effect of the two components of FAM diffusion, Frequency-Modulated Denoising (FM) and Attention Modulation (AM), may be studied. The results shown in FIGS. 4A to 4E indicate the following: (1) both direct inference from random noise, and direct inference from the diffused latent at native resolution generate outputs with structural distortions and repeated patterns; (2) while the Skip Residuals of DemoFusion helps maintain the global structure of the image, it still produces artifacts and poor local patterns; (3) compared to Skip Residuals, FM may reduce undesirable local patterns by leveraging the low-frequency information of the image at native resolution, which provides better structural guidance; (4) Attention Modulation may resolve inconsistencies between local patterns and global structure by utilizing the attention map from the native resolution, offering strong guidance of the semantic relationships among latent tokens. Overall, FM and AM may address structural distortions and local pattern inconsistencies in high-resolution images effectively, highlighting the meaningful contributions of FAM diffusion.

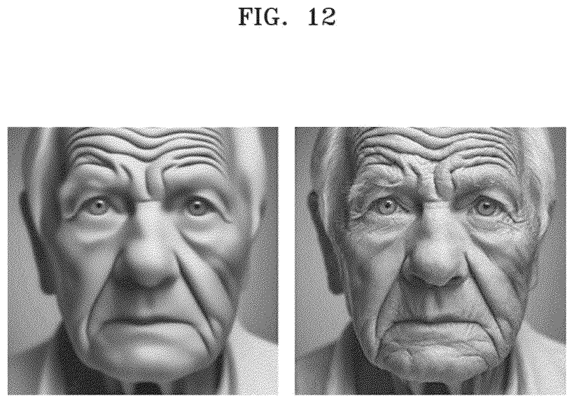

Effectiveness of the time-aware formulation on the FM module: The effect of the time-varying formulation of FM is shown, as illustrated in FIG. 12. FIG. 12 illustrates a comparison between images generated using constant low-frequency information (left) and time-aware low-frequency information (right) according to an embodiment of the disclosure. Specifically, the FM module may incorporate low-frequency information from the corresponding diffused latent at each step t. Instead, this time-varying nature can be avoided by utilising the upsampled latent as a single static reference. However, this approach may result in images that appear noticeably blurrier (left image) and lose finer details associated with high-frequency information, highlighting the importance of the dynamic nature of the FM module throughout the denoising process.

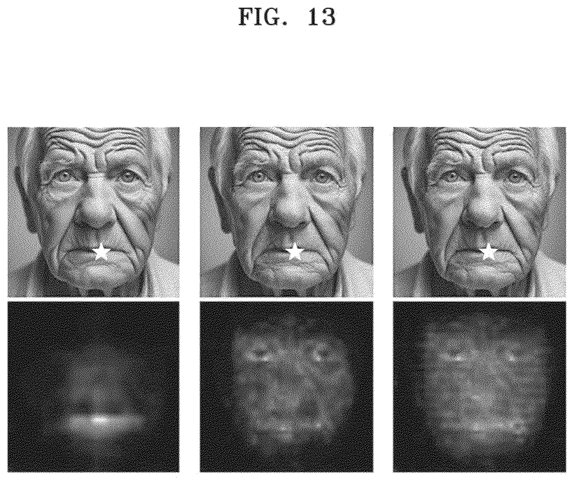

Analysis of Attention Modulation: To better understand the principles underlying the AM module, FIG. 13 visualised the self-attention maps of a tokens from the mouth region (marked with a star) as the query and all tokens as the key and value. The left images may be based on low resolution attention, the middle images may be based on high resolution attention, and the right images may be based on the present attention modulation. The resulting attention map computed using the low-resolution latent (left) primarily encodes coarse information of the semantic relations among parts of the image, but lacks fine-grained contextual information across the entire face. Instead, the attention maps at high resolution (middle) may be more detailed, but fail to capture semantic relatedness, e.g., the mouth areas are not highlighted. After applying AM, the attention map (right) may effectively integrate local-global relationships with enhanced fine-grained detail. This analysis may provide visual insights into how AM repairs inconsistencies in local patterns, contributing to more coherent global structures.

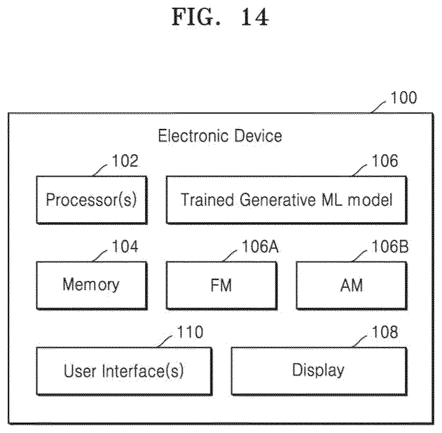

FIG. 14 illustrates a block diagram of an electronic device 100 for adapting a trained generative machine learning, ML, model 106 to generate high-resolution images according to an embodiment of the disclosure, the electronic device comprising: at least one processor 102 coupled to memory 104, for performing the methods described herein.

The device 100 may comprise at least one user interface 110 to, for example, receive text prompts from a user.

The user device may comprise a display 108 for display the generated images.

The user device may comprise an FM module 106A and may comprise an AM module 106B for implementing the present techniques during inference time.

The electronic device 100 may comprise at least one processor 102 coupled to memory 104 and arranged for implementing the methods described herein. The memory 104 may store instructions that, when executed by the at least one processor 102 individually or collectively, cause the electronic device to perform the methods described herein.

According to an embodiment of the disclosure, a method for generating, on an electronic device, high-resolution images using a generative machine learning, ML, model is provided.

In an embodiment, the method may comprise displaying the generated third image on a display of the electronic device.

In an embodiment, the method, wherein generating the third image may comprise, at the each second denoising timestep of the plurality of second denoising timesteps: generating, using a frequency modulation module, a frequency-modulated version of the second noisy image, wherein the frequency modulation module may ensure the global structural features are maintained; and inputting the frequency-modulated version of the second noisy image into the generative ML model for denoising.

In an embodiment, the method, wherein, at the each second denoising timestep, generating the frequency-modulated version of the second noisy image may comprise inputting the stored noised latent representation of the corresponding noising timestep and the denoised latent representation of the second denoising timestep into the frequency modulation module.

In an embodiment, the method, wherein, at the each second denoising timestep, generating the frequency-modulated version of the latent representation may comprise applying a low-pass filter to the stored noised latent representation of the corresponding noising timestep, to retain low-frequency components of the stored noisy latent representation, wherein the low-frequency components may correspond to the global structural features in the second image.

In an embodiment, the method, wherein, at the each second denoising timestep, generating the frequency-modulated version of the latent representation may comprise applying a high-pass filter to the denoised latent representation of the second denoising timestep, to retain high-frequency components of the denoised latent representation, wherein the high-frequency components may correspond to local structural features in the second image.

In an embodiment, the method, wherein, at the each second denoising timestep, generating the frequency-modulated version of the latent representation may comprises combining the retained low-frequency components of the stored noised latent representation and the retained high-frequency components of the denoised latent representation, to generate the frequency-modulated version of the latent representation of the second noisy image.

In an embodiment, the method, wherein prior to generating the frequency-modulated version of the second noisy image, the method may comprise converting, using a Fast Fourier Transform, the stored noised latent representation of the corresponding noising timestep and the denoised latent representation of the second denoising timestep into a Fourier domain.

In an embodiment, the method, wherein prior to inputting the frequency-modulated version of the second noisy image into the generative ML model for denoising, the method may comprise applying an inverse Fast Fourier Transform to the generated frequency-modulated version of the latent representation of the second noisy image.

In an embodiment, the method, wherein generating the first image by denoising the first noisy image may comprise generating, at each first denoising timestep, an attention map at the initial resolution, wherein each attention map may guide the generative ML model to focus on particular parts of the first noisy image; and storing the generated attention maps.

In an embodiment, the method, wherein generating the third image, at the each second denoising timestep of the plurality of denoising timesteps may comprise generating an attention map at the target resolution; and incorporating, using an attention modulation module, information from the stored upsampled attention map from a corresponding first denoising timestep into the generated attention map at the target resolution, to transfer local structural features from the first image to the third image.

In an embodiment, the method, wherein the generative ML model may comprise a plurality of layers, and the method may further comprise incorporating the information from the stored upsampled attention map into the generated attention map during processing by a subset of the plurality of layers of the generative ML model.

In an embodiment, the method, wherein obtaining the text prompt to generate the image may comprise obtaining a text prompt to generate a single image. The method, wherein generating the third image at the target resolution may comprise generating the single image.

In an embodiment, the method, wherein obtaining the text prompt to generate the image may comprise obtaining a text prompt to generate a video including a plurality of frames. The method, wherein generating the third image at the target resolution may comprise generating the plurality of frames.

According to an embodiment of the disclosure, an electronic device for generating high-resolution images using a generative machine learning, ML, model is provided. The electronic device may comprise memory storing instructions and at least one processor operatively coupled to the memory and comprising processing circuitry.

In an embodiment, the electronic device, the at least one processor may individually or collectively execute the instructions to cause the electronic device to display the generated third image on a display of the electronic device.

In an embodiment, the electronic device, wherein to generate the third image, at the each second denoising timestep of the plurality of second denoising timesteps, the at least one processor may individually or collectively execute the instructions to cause the electronic device to generate, using a frequency modulation module, a frequency-modulated version of the second noisy image, wherein the frequency modulation module may ensure the global structural features are maintained; and input the frequency-modulated version of the second noisy image into the generative ML model for denoising.

In an embodiment, the electronic device, wherein, at the each second denoising timestep, to generate the frequency-modulated version of the second noisy image, the at least one processor may individually or collectively execute the instructions to cause the electronic device to input the stored noised latent representation of the corresponding noising timestep and the denoised latent representation of the second denoising timestep into the frequency modulation module.

In an embodiment, the electronic device, wherein, at the each second denoising timestep, to generate the frequency-modulated version of the latent representation, the at least one processor may individually or collectively execute the instructions to cause the electronic device to apply a low-pass filter to the stored noised latent representation of the corresponding noising timestep, to retain low-frequency components of the stored noisy latent representation, wherein the low-frequency components may correspond to the global structural features in the second image.

It should be understood that the frequency modulation described herein is performed by a frequency modulation module, which may include one or more processors, circuits, or software components configured to execute the frequency modulation operations.

Likewise, the attention modulation described herein is performed by an attention modulation module, which may include one or more processors, circuits, or software components configured to execute the attention modulation operations.

The term “module” as used herein encompasses hardware, firmware, software, or combinations thereof, and is not limited to a particular implementation. Therefore, the frequency modulation module and the attention modulation module may be implemented in various forms without departing from the scope of the present disclosure.

### REFERENCES

DemoFusion—Ruoyi Du, Dongliang Chang, Timothy Hospedales, Yi-Zhe Song, and Zhanyu Ma. DemoFusion: Democratising high resolution image generation with no $$$. In IEEE Conference on Computer Vision and Pattern Recognition, 2024
HiDiffusion—Shen Zhang, Zhaowei Chen, Zhenyu Zhao, Yuhao Chen, Yao Tang, and Jiajun Liang. HiDiffusion: Unlocking higher resolution creativity and efficiency in pretrained diffusion models. In European Conference on Computer Vision, 2024
Stable Diffusion (SD)—Robin Rombach, Andreas Blattmann, Dominik Lorenz, Patrick Esser, and Bjorn Ommer. High-resolution image synthesis with latent diffusion models. In IEEE Conference on Computer Vision and Pattern Recognition, 2022.
SDXL—Dustin Podell, Zion English, Kyle Lacey, Andreas Blattmann, Tim Dockhorn, Jonas Muller, Joe Penna, and Robin Rombach. SDXL: Improving latent diffusion models for high-resolution image synthesis. In International Conference on Learning Representations, 2024
AccDiffusion—Zhihang Lin, Mingbao Lin, Zhao Meng, and Rongrong Ji. AccDiffusion: An accurate method for higher-resolution image generation. In European Conference on Computer Vision, 2024
FouriScale—Linjiang Huang, Rongyao Fang, Aiping Zhang, Guanglu Song, Si Liu, Yu Liu, and Hongsheng Li. FouriScale: A frequency perspective on training-free high-resolution image synthesis. In European Conference on Computer Vision, 2024.
Laion-5B dataset—Christoph Schuhmann, Romain Beaumont, Richard Vencu, Cade W Gordon, Ross Wightman, Mehdi Cherti, Theo Coombes, Aarush Katta, Clayton Mullis, Mitchell Wortsman, Patrick Schramowski, Srivatsa R Kundurthy, Katherine Crowson, Ludwig Schmidt, Robert Kaczmarczyk, and Jenia Jitsev. LAION-5B: An open large-scale dataset for training next generation image-text models. In Neural Information Processing Systems—Datasets and Benchmarks Track, 2022.
Frechet Inception Distance (FID)—Martin Heusel, Hubert Ramsauer, Thomas Unterthiner, Bernhard Nessler, and Sepp Hochreiter. GANs trained by a two time-scale update rule converge to a local Nash equilibrium. Neural Information Processing System
Kernel Inception Distance (KID)—Mikotaj Binkowski, Danica J Sutherland, Michael Arbel, and Arthur Gretton. Demystifying MMD GANs. International Conference on Learning Representations, 2018.
CLIP score—Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervision. In International conference on machine learning, pages 8748-8763. PMLR, 2021
FreeU—Chenyang Si, Ziqi Huang, Yuming Jiang, and Ziwei Liu. FreeU: Free lunch in diffusion U-Net. In IEEE Conference on Computer Vision and Pattern Recognition, 2024.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A method for generating, on an electronic device, high-resolution images using a generative machine learning, ML, model, the method comprising:
obtaining a text prompt to generate an image, and a first noisy image;
generating a first image according to the text prompt and at an initial resolution, by denoising the first noisy image using the generative ML model over a plurality of first denoising timesteps, wherein the generative ML model has been trained using images having the initial resolution;
upsampling, using an upsampling module, the generated first image to produce a second image having a target resolution, wherein the target resolution is higher than the initial resolution;
adding noise to the second image using the generative ML model over a plurality of noising timesteps, to generate a second noisy image at the target resolution, by:
adding noise to a latent representation of the second image generated at a previous noising timestep, and
storing the noised latent representation; and
generating a third image at the target resolution, by:
denoising the second noisy image using the generative ML model over a plurality of second denoising timesteps, wherein each second denoising timestep corresponds to a noising timestep, and
during the each second denoising timestep, ensuring global structural features in the second image are maintained, wherein the global structural features are obtained from the stored noised latent representation for the corresponding noising timestep.

2. The method of claim 1, further comprising:
displaying the generated third image on a display of the electronic device.

3. The method of claim 1, wherein generating the third image comprises, at the each second denoising timestep of the plurality of second denoising timesteps:
generating, using a frequency modulation module, a frequency-modulated version of the second noisy image, wherein the frequency modulation module ensures the global structural features are maintained; and
inputting the frequency-modulated version of the second noisy image into the generative ML model for denoising.

4. The method of claim 3, wherein, at the each second denoising timestep, generating the frequency-modulated version of the second noisy image comprises:
inputting the stored noised latent representation of the corresponding noising timestep and the denoised latent representation of the second denoising timestep into the frequency modulation module.

5. The method of claim 3, wherein, at the each second denoising timestep, generating the frequency-modulated version of the latent representation comprises:
applying a low-pass filter to the stored noised latent representation of the corresponding noising timestep, to retain low-frequency components of the stored noisy latent representation, wherein the low-frequency components correspond to the global structural features in the second image.

6. The method of claim 5, wherein, at the each second denoising timestep, generating the frequency-modulated version of the latent representation comprises:
applying a high-pass filter to the denoised latent representation of the second denoising timestep, to retain high-frequency components of the denoised latent representation, wherein the high-frequency components correspond to local structural features in the second image.

7. The method of claim 6, wherein, at the each second denoising timestep, generating the frequency-modulated version of the latent representation comprises:
combining the retained low-frequency components of the stored noised latent representation and the retained high-frequency components of the denoised latent representation, to generate the frequency-modulated version of the latent representation of the second noisy image.

8. The method of claim 4, wherein prior to generating the frequency-modulated version of the second noisy image, the method comprises:
converting, using a Fast Fourier Transform, the stored noised latent representation of the corresponding noising timestep and the denoised latent representation of the second denoising timestep into a Fourier domain.

9. The method of claim 8, wherein prior to inputting the frequency-modulated version of the second noisy image into the generative ML model for denoising, the method comprises:
applying an inverse Fast Fourier Transform to the generated frequency-modulated version of the latent representation of the second noisy image.

10. The method of claim 1, wherein generating the first image by denoising the first noisy image comprises:
generating, at each first denoising timestep, an attention map at the initial resolution, wherein each attention map guides the generative ML model to focus on particular parts of the first noisy image; and
storing the generated attention maps.

11. The method of claim 10, wherein generating the third image, at the each second denoising timestep of the plurality of denoising timesteps comprises:
generating an attention map at the target resolution; and
incorporating, using an attention modulation module, information from the stored upsampled attention map from a corresponding first denoising timestep into the generated attention map at the target resolution, to transfer local structural features from the first image to the third image.

12. The method of claim 11, wherein the generative ML model comprises a plurality of layers, and the method further comprises:
incorporating the information from the stored upsampled attention map into the generated attention map during processing by a subset of the plurality of layers of the generative ML model.

13. The method of claim 1, wherein:
obtaining the text prompt to generate the image comprises obtaining a text prompt to generate a single image; and
generating the third image at the target resolution comprises generating the single image.

14. The method of claim 1, wherein:
obtaining the text prompt to generate the image comprises obtaining a text prompt to generate a video including a plurality of frames; and
generating the third image at the target resolution comprises generating the plurality of frames.

15. An electronic device for generating high-resolution images using a generative machine learning, ML, model, the electronic device comprising:
memory storing instructions; and
at least one processor operatively coupled to the memory and comprising processing circuitry,
wherein the at least one processor individually or collectively executes the instructions to cause the electronic device to:
obtain a text prompt to generate an image, and a first noisy image;
generate a first image according to the text prompt and at an initial resolution, by denoising the first noisy image using the trained generative ML model over a plurality of first denoising timesteps, wherein the generative ML model has been trained using images having the initial resolution;
upsample, using an upsampling module, the generated first image to produce a second image having a target resolution, wherein the target resolution is higher than the initial resolution;
add noise to the second image using the generative ML model over a plurality of noising timesteps, to generate a second noisy image at the target resolution, by:
adding noise to a latent representation of the second image generated at a previous noising timestep, and
storing the noised latent representation in storage on the electronic device; and
generate a third image at the target resolution, by:
denoising the second noisy image using the generative ML model over a plurality of second denoising timesteps, wherein each second denoising timestep corresponds to a noising timestep, and
during the each second denoising timestep, ensuring global structural features in the second image are maintained, wherein the global structural features are obtained from the stored noised latent representation for the corresponding noising timestep.

16. The electronic device of claim 15, the at least one processor individually or collectively executes the instructions to cause the electronic device to:
display the generated third image on a display of the electronic device.

17. The electronic device of claim 15, wherein to generate the third image, at the each second denoising timestep of the plurality of second denoising timesteps, the at least one processor individually or collectively executes the instructions to cause the electronic device to:
generate, using a frequency modulation module, a frequency-modulated version of the second noisy image, wherein the frequency modulation module ensures the global structural features are maintained; and
input the frequency-modulated version of the second noisy image into the generative ML model for denoising.

18. The electronic device of claim 17, wherein, at the each second denoising timestep, to generate the frequency-modulated version of the second noisy image, the at least one processor individually or collectively executes the instructions to cause the electronic device to:
input the stored noised latent representation of the corresponding noising timestep and the denoised latent representation of the second denoising timestep into the frequency modulation module.

19. The electronic device of claim 17, wherein, at the each second denoising timestep, to generate the frequency-modulated version of the latent representation, the at least one processor individually or collectively executes the instructions to cause the electronic device to:
apply a low-pass filter to the stored noised latent representation of the corresponding noising timestep, to retain low-frequency components of the stored noisy latent representation, wherein the low-frequency components correspond to the global structural features in the second image.

20. One or more non-transitory computer-readable storage media storing one or more computer programs including computer-executable instructions that, when executed by one or more processors of an electronic device, cause the electronic device to perform operations, the operations comprising:
obtaining a text prompt to generate an image, and a first noisy image;
generating a first image according to the text prompt and at an initial resolution, by denoising the first noisy image using the generative ML model over a plurality of first denoising timesteps, wherein the generative ML model has been trained using images having the initial resolution;
upsampling, using an upsampling module, the generated first image to produce a second image having a target resolution, wherein the target resolution is higher than the initial resolution;
adding noise to the second image using the generative ML model over a plurality of noising timesteps, to generate a second noisy image at the target resolution, by:
adding noise to a latent representation of the second image generated at a previous noising timestep, and
storing the noised latent representation; and
generating a third image at the target resolution, by:
denoising the second noisy image using the generative ML model over a plurality of second denoising timesteps, wherein each second denoising timestep corresponds to a noising timestep, and
during the each second denoising timestep, ensuring global structural features in the second image are maintained, wherein the global structural features are obtained from the stored noised latent representation for the corresponding noising timestep.
